(19) United States
(12) Patent Application Publication
(10) Pub. No.: US 2025/0288995 A1
(43) Pub. Date: Sep. 18, 2025

(54) ASSAY OPTIMIZATION CENTRIFUGAL MICROFLUIDIC DISC, METHODS OF USING, AND METHODS OF MAKING

(71) Applicant: University of Virginia Patent Foundation, Charlottesville, VA (US)

(72) Inventors: Renna L. Nouwairi, Fishersville, VA (US); Carter K. Jones, Charlottesville, VA (US); Maura E. Charette, Spotsylvania, VA (US); Emilee A. Carter, Charlottesville, VA (US); Zoey Zi Ting Golabek, Springfield, VA (US); James P. Landers, Charlottesville, VA (US)

(21) Appl. No.: 19/081,864

(22) Filed: Mar. 17, 2025

Related U.S. Application Data
(60) Provisional application No. 63/566,042, filed on Mar. 15, 2024.

(51) Int. Cl. B01L 3/00

(52) U.S. Cl. CPC B01L 3/502738; B01L 3/50273; B01L 2200/0605; B01L 2200/0621; B01L 2300/087; B01L 2400/0409

(57) ABSTRACT

The present disclosure provides for devices, systems, methods of using, and method of making an assay optimization centrifugal microfluidic device. The centrifugal microfluidic device includes a sample preparation domain. The sample preparation domain includes a first reagent chamber and a first distribution channel in fluidic communication with the first reagent chamber. The sample preparation device further includes a first network of metering channels furcating from the first distribution channel and a first plurality of valves, with individual valves in fluidic communication with individual metering channels. Additionally, the sample preparation domain includes a plurality of detection chambers with individual detection chambers connected to individual valves.

### CROSS REFERENCE TO RELATED APPLICATIONS

This application claims priority to, and the benefit of, co-pending U.S. provisional application entitled “AUTOMATED ASSAY OPTIMIZATION ON A MICROFLUIDIC DISC AND RELATED METHODS THEREOF” having Ser. No. 63/566,042, filed on Mar. 15, 2024, the entirety of which is hereby incorporated by reference.

### BACKGROUND

Optimizing multi reagent assays often requires successive titration of individual components until the optimal combination of conditions is achieved. This process can be time consuming, laborious, and often expensive since parallelized experimentation requires bulk consumption of reagents. While ‘neural networks’, a nascent form of artificial intelligence, allows for a multiparameter/multi-reagent analytical process to be optimized with fewer experiments, extensive empirical experimentation is still required. To evaluate the mixing of four reagents at a number of different concentrations, the number of possible combinations can be calculated. For example, if Reagent A (3 concentrations) were to be combined with Reagent B (4 concentrations), Reagent C (3 concentrations), Reagent D (2 concentrations), and Reagent E (2 concentrations) for a particular assay, the number of combinations and permutations would be 144 (3×4×3×2×2). While single-digit microliter reactions can be effective, scaling to nanoliter volumes without employing droplets is not straight-forward.

### SUMMARY

In accordance with the purpose(s) of this disclosure, as embodied and broadly described herein, the disclosure, in various aspects, relates to an assay optimization centrifugal microfluidic device. According to various aspects of the present disclosure, there is provided a centrifugal microfluidic device, comprising: a sample preparation domain, comprising: a first reagent chamber; a first distribution channel in fluidic communication with the first reagent chamber; a first network of metering channels furcating from the first distribution channel; a first plurality of valves, with individual valves in fluidic communication with individual metering channels; and a plurality of detection chambers with individual detection chambers connected to individual valves.

The present disclosure also provides for methods for metering a fluid, comprising: rotating the centrifugal microfluidic device, rotationally driving the fluid through a network of metering channels and into a plurality of valves, wherein individual valves have a top region adjacent the individual metering channel and a bottom region on the side opposite the individual metering channel; forming a first opening at a first location in individual valves, wherein the first location is in the top region of the individual valve; and rotating the centrifugal microfluidic device, rotationally driving a first specified amount of the fluid from the plurality of valves to a plurality of detection chambers, wherein the first specified amount of the fluid is based at least in part on a radial distance of the first opening of the individual valves and the first location of the first opening.

In some aspects, the present disclosure provides for methods of metering a plurality of fluids, comprising: loading a first fluid into a first set of reagent chambers of a centrifugal microfluidic device; loading a second fluid into a second set of reagent chambers of the centrifugal microfluidic device; rotating the centrifugal microfluidic device, rotationally driving the first fluid through a first network of metering channels and into a first set of valves and the second fluid through a second network of metering channels and into a second set of valves; forming an opening in individual valves of the first set of valves and the second set of valves; and rotating the centrifugal microfluidic device, rotationally driving a first specified amount of the first fluid from the first set of valves and a second specified amount of the second fluid from the second set of valves to a plurality of detection chambers.

In various aspects of the present disclosure, a system is provided comprising: a laser, and a centrifugal microfluidic device with a plurality of layers forming a body, wherein the body comprises a plurality of sample preparation domains, individual sample preparation domains comprising: one or more reagent chambers; one or more networks of metering channels furcating from the one or more reagent chambers; one or more sets of a plurality of valves distributed among the one or more networks of metering channels such that individual metering channels fill individual valves; one or more waste chambers connected to the one or more networks of metering channels for reagent overflow; a plurality of detection chambers with individual detection chambers connected to one or more individual valves; and a plurality of vents with individual vents attached to individual valves.

Other systems, methods, devices, features, and advantages of the devices and methods will be or become apparent to one with skill in the art upon examination of the following drawings and detailed description. It is intended that all such additional systems, methods, devices, features, and advantages be included within this description, be within the scope of the present disclosure, and be protected by the accompanying claims.

### BRIEF DESCRIPTION OF THE DRAWINGS

Further aspects of the present disclosure will be more readily appreciated upon review of the detailed description of its various embodiments, described below, when taken in conjunction with the accompanying drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-C illustrates the working principles of the power, time, and z-height adjustable laser (PrTZAL) system and active valving method being implemented according to various embodiments of the present disclosure. FIG. 1A depicts the custom-built mechatronic PrTZAL system that accurately positions the laser over a valve by spinning a disc mounted to a linear actuator that moves in the x-direction (adapted from Woolf et al. (23)). FIG. 1B is a diagram showing a top view of a microfluidic disc containing holes to mount the disc to the PrTZAL system. The red “X” represents a valve set a distance (d) from the center of rotation at an angular distance (Θ) form a homing notch. The photo-interrupting optical switch enables the system to spin the disc to a set angle as defined by the homing notch while the linear actuator radially positions the disc relative to the laser. FIG. 1C shows a side view of the 5-layer microfluidic disc depicting the dual-stage metering workflow, including (i) loading and aliquoting reagents, (ii) opening the normally-closed valves via laser ablation, (iii) spinning fluid through the valve to the (iv) detection chamber.

FIGS. 2A and 2B illustrate an example of the microfluidic architecture for the rotationally-driven nanoliter metering disc according to various embodiments of the present disclosure. FIG. 2A is an exploded view of 5-layer disc consisting of polyethylene terephthalate (PeT) (layers 1 and 5), fluidic layers (layers 2 and 4) comprised of PeT with a heat-sensitive adhesive (HSA) on both sides, and a separation layer of black PeT for laser-actuated valving (layer 3). The accessory pieces, consisting of poly (methyl methacrylate) (PMMA) capped with PeT, are attached to the 5-layer disc via a pressure-sensitive adhesive (PSA). FIG. 2B illustrates the centrifugal microfluidic disc containing 6 domains as viewed from the top. The inset depicts a single domain.

FIG. 3 illustrates a digitally scanned image of the fully assembled centrifugal microfluidic disc and a dye study illustrating the two-way metering working principle according to various embodiments of the present disclosure. The insets of FIG. 3 depict the nanoliter metering workflow, including (A) loading fluid into the reagent chamber, (B) stage 1 metering from the reagent chamber to the valves, and (C) stage 2 metering of fluid into the detection chamber post-valve opening.

FIG. 4 shows a calibration curve correlating pixel count to a known volume for objective determination of fluid metered into the detection chambers according to various embodiments of the present disclosure.

FIG. 5 depicts a three-dimensional schematic of the dual-stage metering principle according to various embodiments of the present disclosure. Stage 1 metering shows a fluid filled microvalve. Next, Stage 2 metering illustrates where the valve is opened via a laser at the (i) top, (ii) center, and (III) bottom of the valve.

FIGS. 6A-D show digitally scanned images of valves after single and consecutive opening(s) to assess instrumental accuracy and precision according to various embodiments of the present disclosure. FIG. 6A illustrates valves opened with a singular laser ablation. FIG. 6B shows valves opened consecutively (n=10) at the center radial and angular position. FIG. 6C depicts enlarged images highlighting the accuracy and precision of opening a valve (i) once or (ii) 10 consecutive times. FIG. 6D shows consecutive valve openings (n=10) at varying (i) radial and (ii) angular positions illustrating the accuracy in opening at varying coordinates and the precision in repeated valved openings.

FIG. 7 depicts an evaluation of valve shape on final metered volume according to various embodiments of the present disclosure. FIG. 7 is a graphic depiction of the liquid volume dispensed as a result of varying valve shape and opening position; percentages above bars represent the percentage of valves opened (n=10). Trendlines for volume metered with each valve shape are shown along with corresponding R-squared.

FIGS. 8A and 8B show representative images illustrating conditions that caused aberrant results according to various embodiments of the present disclosure. FIG. 8A depicts scanned images of valves opened at varying laser positions with arrows indicating air pockets created by laser ablation that trapped fluid in the valves. FIG. 8B shows two conditions responsible for overestimation of fluid in the detection chamber, including (i) residual fluid in the metering channel that caused the final volume to exceed 700 nL, and (ii) shadows in the detection chambers resulting from scanned images.

FIGS. 9A-C depict an evaluation of valve opening positions on final metered volume according to various embodiments of the present disclosure. A comparison of recovered fluid volumes as a result of valve actuation in different radial positions (FIG. 9A), angular positions (FIG. 9B), or rotational directions (FIG. 9C).

FIG. 10 illustrates demonstrating different strategies to adjust the final metered volume according to various embodiments of the present disclosure. Changes in volume as a result of reducing the valve size compared to reducing the length of the channel leading to the valve. The original valve size (middle right set) was reduced to half (middle left set) and a quarter (far left set) of the original area, and the length of the metering channel leading to the valve was reduced by half (far right set). The striped bars represent the percent of successful valve openings.

FIGS. 11A-C illustrate the dye study demonstrating application of two-stage metering principle to colorimetrically detect a titrated analyte according to various embodiments of the present disclosure. FIG. 11A depicts a scanned image of a microfluidic disc for nanoliter metering of two reagents into detection chambers. The inset contains a labeled schematic of a single domain. FIG. 11B shows a dye study demonstrating the workflow implemented for colorimetric detection of cocaine at differing concentrations: (i) dye was pipetted into the disc and (ii) metered to valves; valves containing (iii) blue and (iv) red dye were sequentially opened and rotationally-driven into the detection chambers. FIG. 11C shows an analysis of hue changes in the detection chamber during each step of the dye study illustrated in FIG. 11B.

FIGS. 12A-C depict application of two-stage metering to colorimetrically detect titrated concentrations of cocaine according to various embodiments of the present disclosure. FIG. 12A shows a scanned image of the disc following metering and addition of titrated cocaine standard to a colorimetric indicator, cobalt (II) thiocyanate. Insets show select valves to illustrate the differences in fluid added for each reagent (cocaine and HCl). FIG. 12B depicts a histogram of hue values present in the indicated chambers with the mode shown (dotted line). FIG. 12C illustrates the results from colorimetric detection of cocaine: the initial hue values when only the colorimetric indicator was present in the detection chambers, and the final hue values upon addition of titrated cocaine standard.

FIGS. 13A and 13B illustrate a nine-layer disc design for titrating PCR primers according to various embodiments of the present disclosure. FIG. 13A shows an exploded view of double-sided 9-layer disc. FIG. 13B depicts scanned images of a 9-layer NMD for metering four reagents into detection chambers. The insets contain labeled schematics of the front and back of one domain.

FIGS. 14A and 14B illustrate optical verification of functionality of fluidic architecture according to various embodiments of the present disclosure. FIG. 14A shows a dye study demonstrating the workflow implemented for titration of forward and reverse primers at different concentrations. Reagents were loaded into (i) the front and (ii) back of the microfluidic disc prior to Stage 1 metering on the (iii) front and (iv) back. Dye was sequentially metered into the detection chambers beginning with (v) green, (vi) blue, (vii) yellow, and (viii) red dye. FIG. 14B shows an objective measurement of hue changes in the detection chambers during the stage 2 metering of reagents (v-viii).

FIG. 15 shows a comparison of PCR primer titration conducted in-tube and on-disc according to various embodiments of the present disclosure. Analysis of average cycle threshold (CT) values for the conventional and microfluidic method.

FIG. 16 shows a scanned image of a microfluidic disc designed to meter six reagents in parallel according to various embodiments of the present disclosure. The inset depicts a single domain as seen from the front of the disc with select images from a dye study to illustrate functionality.

FIG. 17 depicts a front view of a disc capable of metering four reagents into one hundred detection chambers according to various embodiments of the present disclosure. The inset is a schematic of a single domain; the images represent the hue gradient produced by metering nanoliter amounts dyes into the detection chambers.

FIG. 18 depicts a scanned image of a single-sided micro disc with a labeled schematic of a domain according to various embodiments of the present disclosure. The outline of the top two valve sets designates the PeT cutout in layers 1-4, and the images illustrate the hue gradient after metering nanoliter amounts of yellow, red, blue, and green dye into the detection chambers.

FIG. 19 illustrates the two-stage metering principle for two reagents on the microdevice according to various embodiments of the present disclosure. After sample loading, stage 1 metering aliquots reagents into fluidic layer 2. The valves in layer 3 are selectively opened to tune the dispensed volume through the laser opening in stage 2 metering. The reagents are then spun into and mixed in the detection chamber.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, microfluidic and centrifugal techniques and the like, which are within the skill of the art. Such techniques are explained fully in the literature.

The following examples are put forth to provide those of ordinary skill in the art with a complete disclosure and description of how to perform the methods and use the compositions and compounds disclosed and claimed herein. Efforts have been made to ensure accuracy with respect to numbers (e.g., amounts, measurements, etc.), but some errors and deviations should be accounted for.

Before the embodiments of the present disclosure are described in detail, it is to be understood that, unless otherwise indicated, the present disclosure is not limited to particular materials, machines, computing processes, or the like, as such can vary. It is also to be understood that the terminology used herein is for purposes of describing particular embodiments only and is not intended to be limiting. It is also possible in the present disclosure that steps can be executed in different sequence where this is logically possible.

It should be noted that ratios, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In some embodiments, the term “about” can include traditional rounding according to significant figures of the numerical value. In addition, the phrase “about ‘x’ to ‘y’”, where ‘x’ and ‘y’ are numerical values, includes “about ‘x’ to about ‘y”.

### Discussion

The present disclosure provides for centrifugal microfluidic devices, systems including centrifugal microfluidic devices, methods of metering fluid, methods of using centrifugal microfluidic devices, methods of making centrifugal microfluidic devices, and the like. Microfluidics presents a solution through miniaturization processes by reducing reaction volume, executing multiple parallel workflows, and enabling an auto-metering process that rapidly yields the desired combinations.

Optimizing multi reagent assays often requires successive titration of individual components until the optimal combination of conditions is achieved. This process is time consuming, laborious, and often expensive since parallelized experimentation requires bulk consumption of reagents. Microfluidics presents a solution through miniaturization of standard processes by reducing reaction volume, executing multiple parallel workflows, and enabling automation. While single-digit microliter reactions can be effective, scaling to nanoliter volumes without employing droplets is difficult.

The present disclosure provides for various embodiments of a customizable centrifugal microfluidic disc for optimizing assays pertinent to a broad array of applications. In some examples, the centrifugal microfluidic disc can conduct an automated two-stage metering process by leveraging tunable, laser-actuated valves that retain defined fluidic volumes upon opening to meter discrete nanoliter volumes into downstream architecture. The centrifugal microfluidic disc of the present disclosure is capable of dispensing volume at the nanoliter scale. In various examples, controlled metering can be achieved for one to four reagents with high parallelization (multiplexing) for rapid assay optimization with minimum manual intervention. Accordingly, various embodiments of the present disclosure are directed to systems and methods for assembling microfluidic assays using a centrifugal microfluidic disc.

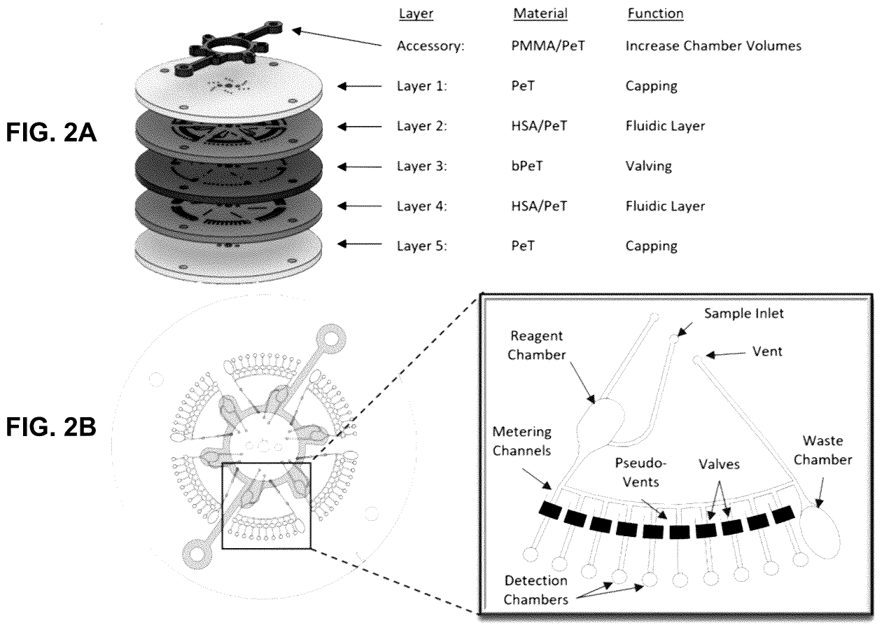

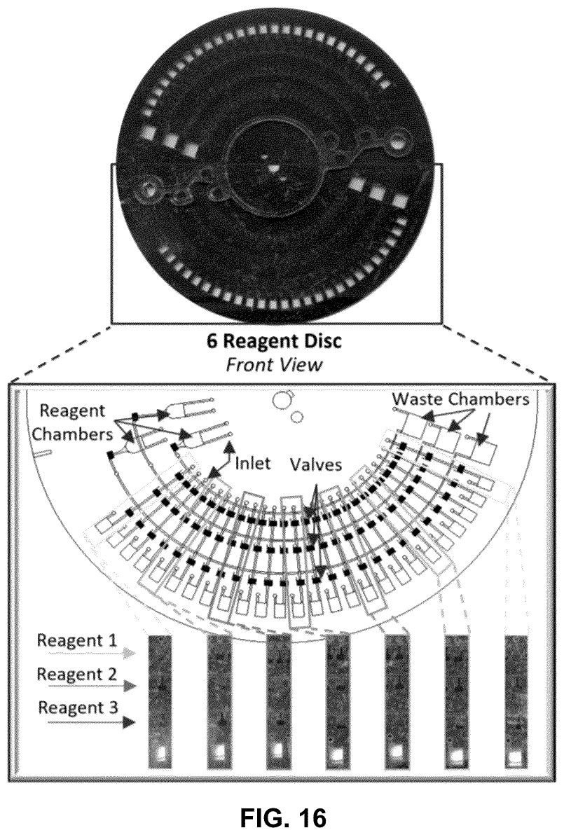

In an aspect, the present disclosure provides for centrifugal microfluidic devices. In an aspect, the centrifugal microfluidic device includes one or more (e.g., 4, 6, 8, 10, or more) sample preparation domains. The number of sample preparation domains on a CD-sized disc depends on the complexity of the domain architecture, the number of reagents involved and their corresponding volumes. If the parallelization capacity is low, as it is in FIG. 16, increased multiplexing can be achieved by increasing the number of layers essentially stacking multiple discs with the necessary through holes to access lower layers. An individual sample preparation domain can include a reagent chamber, a distribution channel, a network of metering channels, valves, and a detection chamber. The sample preparation domain can receive fluid via an inlet chamber that is connected to the reagent chamber. The vast majority of reagents used in microfluidics are largely dominated by water, hence, their viscosity is typically equal to or approximately that of water. Sample viscosity can vary dramatically with whole blood being 5× more viscous and 50% glycerol 100×. Most organic solvents used in microfluidics are close to or higher than the viscosity of water, e.g., ethanol is 1.2× that of water. Should a particular reagent present a higher viscosity, this can be overcome by simply increasing the centrifugal force with higher rotation speeds. The fluid can exit the reagent chamber through a connection with the distribution channel. A first end of the distribution channel is connected to the reagent chamber and the other end of the distribution channel is connected to a waste chamber where excess fluid can flow. Along the distribution channel, individual metering channels can branch off from the distribution channel. The individual metering channels can be tapered to encourage fluid to flow into the metering channels, residual fluid can continue along the distribution channel and into the waste chamber. The metering channel therefore at one end can connect to the distribution channel and the other end of each metering channel connects to a valve. The valve can initially be closed, allowing for the fluid to distribute among the valves via the distribution channel and metering channels. When the valves are opened, which can be accomplished via laser ablation, the fluid can flow from the valves and into respective detection chambers. FIG. 2B illustrates an embodiment of the centrifugal microfluidic device.

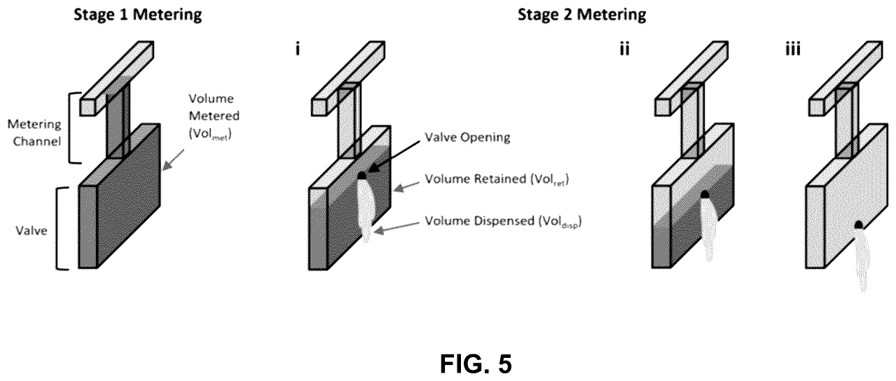

In an aspect, the present disclosure provides for a method for variable metering fluid, which can be accomplished using the centrifugal microfluidic devices described herein. In an aspect, the method can include rotating (e.g., in a centrifuge) the centrifugal microfluidic device, causing the fluid to be rotationally driven (e.g., centrifugal force) from the reagent chamber and through the distribution channel and the network of metering channels and into the valves. In some aspects, the valving can be in a rectangular or other polygonal shaped chip where flow can be driven by mobilization approaches (e.g., pressure or vacuum). Each valve can have a top region and a bottom region with the top region being in open connection with the metering channel and allowing for the free flow of fluid entering the valve. The bottom region can have a closed connection to the detect chamber. While this connection remains closed, fluid can be prevented from flowing from the valve and to the detection chamber. Some aspects of the method include forming an opening at a location(s) of each valve, where the opening can be formed using laser energy. The method can further include once again rotating the centrifugal microfluidic device, rotationally driving a specified amount of the fluid from the valve and into the detection chamber via the connection (e.g., a channel) formed at the bottom region of the valve in open connection through the laser formed opening. The amount of fluid flowing from the valve can be tuned to a specified amount as the amount of fluid flow from the valve can be manipulated based at least in part on the location of the opening. FIG. 5 provides an illustration of a three-stage metering method.

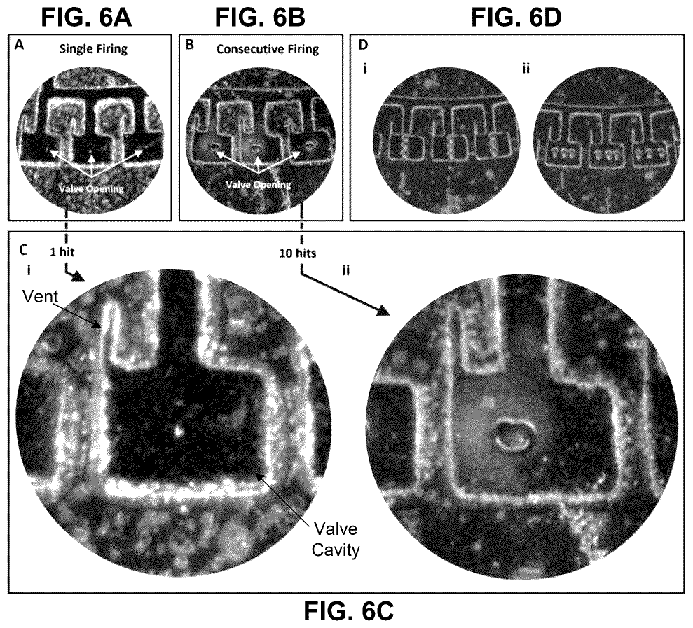

In an embodiment, the repeatability of this process correlates to the accuracy of the PRZTL system to hit the same location on the valve. This is shown in FIG. 6C where multiple laser shots overlap the original single hit. As shown in FIG. 6C, the repeatability in the ‘x’ direction is very good, but the variability is apparent in the ‘y’ direction. Alignment accuracy in the ‘y’ direction is defined by the movement of the laser (on an ‘x’ translator) from the disc center to the periphery. However, the position in the ‘y’ direction is determined by the motor and its ability to find the desired position based on a ‘homing’ algorithm. For example, if the low-cost motor used here can home circumferentially with an accuracy of ±0.5°, then the disc (e.g., a 720-slice pie) can be tuned to be stopped at any one of those positions, and it is that parameter that accounts for the drift in the ‘y’ direction in FIG. 6C. Clearly, a motor with better homing accuracy (e.g., ±0.1°) would minimize the ‘y’ direction drift. However, the reproducibility in draining of the fluid volume contained in the valve cavity is dominated by hitting the appropriate position in the ‘x’ direction (FIG. 5).

In the following discussion, a general description of the centrifugal microfluidic devices and systems is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

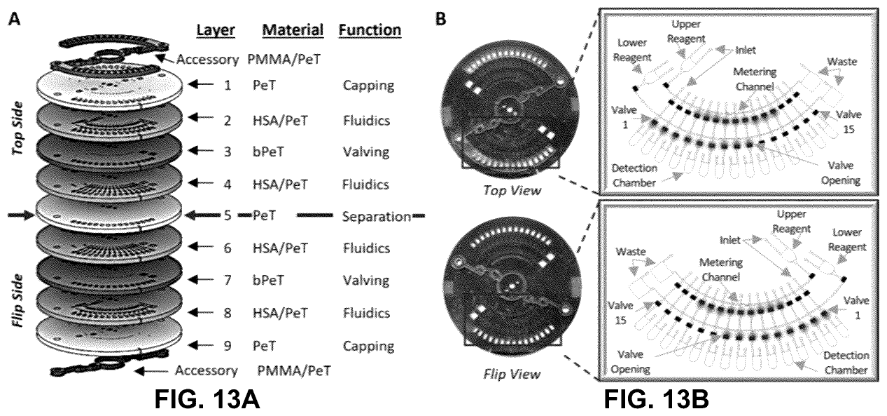

With reference to FIG. 2A, shown is one example of the centrifugal microfluidic device according to various embodiments of the present disclosure. While FIG. 2A illustrates a 5-layer centrifugal microfluidic device, the present disclosure can employ any number of layers (9-layer disc illustrated in FIG. 13A). One layer of the microfluidic disc can have an approximate diameter of about 130 mm to 160 mm. As shown in FIG. 2A, the first layer and the fifth layer, according to this example, can be clear polyethylene terephthalate (PeT) layers and can serve as capping layers. The second and fourth layers can be composed of or incorporate some type of adhesive, e.g. a pressure or heat sensitive adhesive, flanked PeT. The second and fourth layers can contain the microfluid architecture. Lastly, the third layer can be composed of optically-dense black PeT (bPeT) and a heat sensitive adhesive for layer bonding. The third layer, in this example, contains the initially closed valving that becomes open via laser ablation thus providing a fluidic connection between the second layer and the fourth layer when opened. Additionally, in some examples, the disc can include an accessory piece that can be composed of PeT and a form of a glassy polymer, e.g. poly(methyl merthacrylate) (PMMA). The accessory piece cab be bonded to the disc to increase chamber volume capacities. While specific materials are described in reference to FIG. 2A, other materials can be used as long as they are consistent with achieving the goals of the centrifugal microfluidic device.

In FIG. 2B, shown is a top view of the microfluid architecture that is dispensed throughout the layers shown in FIG. 2A. FIG. 2B illustrates an exploded view of a sample preparation domain. This microfluid architecture of the sample preparation domain of a centrifugal microfluidic device can include: a reagent chamber, a distribution channel, metering channels, a waste chamber, valves, detection chambers, and vents.

The reagent chamber can receive the initial inflow of fluid to be dispensed. The reagent chamber can thus be filled with a fluid manually pipetted into the microfluidic device via an inlet channel or using an automated loading device. The inlet channel can enable loading of a fluid into the individual sample preparation domains, including various reagent chambers (FIG. 2B illustrates 6, but 2, 4, 8, 10, 12, or more can be produced). The reagent chamber can have a cross-sectional shape such as a circle, an oval, a rectangle, a polygon, etc. In some examples, the reagent chamber can have a longest dimension (e.g., a diameter or length or width) of about 10 mm to 50 mm or about 12 mm to 25 mm. Further, the reagent chambers can hold about 5 μL to 20 μL; in some examples, the reagent chambers can hold about 10 μL of fluid.

The reagent chamber can be connected at a bottom region (e.g., a region that is furthest from a central point of the centrifugal microfluidic device so that the rotational force can drive the fluid from the reagent chamber) to a distribution channel so that the fluid can freely flow from the reagent chamber and into the distribution channel by rotational forces. One end of the distribution channel can be connected to the reagent chamber and the other end of the distribution channel can be connected to the waste chamber. The distribution channel can have a length of about 0.5 cm to 5 cm. The distribution channel can have a diameter (or width) of about 50 μm to 1000 μm, or about 150 μm to 300 μm. Along the length of the distribution channel, metering channels can periodically branch off from the distribution channel.

The metering channels can be in fluidic communication with the distribution channel. At various increments along the distribution channel, a metering channel furcates from the distribution channel, branching down (e.g., in a direction away from the central point of the centrifugal microfluidic device) towards the valves. The metering channels can have a length of about 0.5 mm to 5 mm or about 1 mm to 3 mm and a diameter of about 50 μm to 1000 μm or about 100 μm to 300 μm. The metering channels can hold a volume of fluid that can range from about 100 nL to 400 nL or is about 200 nL. The metering channels can also be tapered (e.g., have a larger cross-sectional opening at the mouth of the metering channel that narrows along at least a portion of the length metering channel towards the valve) to encourage fluid to flow from the distribution channel and into the metering channel before continuing along the distribution channel and into the waste chamber. Thus, the top region of the metering channel that can connect to the distribution channel can have a larger cross-sectional dimension (e.g., diameter or width) than the bottom region of the metering channel which can connect to a valve.

The distribution channel can end at a waste chamber. The waste chamber can store any overflow fluid that is not distributed to the metering channels. The waste chamber can have a cross-sectional shape such as a circular cross-section, an oval cross-section, a rectangular cross-section, a polygon cross-section, etc. The waste chamber can have a longest dimension (length) of about 10 mm to 30 mm. Further, the waste chamber can hold about 10 μL to 250 μL; in some examples, the waste chamber can hold approximately 100 μL of fluid.

Each metering channel can connect to a top region of a valve. According to various embodiments of the present disclosure, the valve would initially be closed, thus fluid would maintain dispensed in the valves and among the metering channels until the valves are opened. In an aspect, the valve can hold approximately 100 nL to 1 μL; in some examples, the valve can hold approximately 500 nL of fluid. In an aspect, the valves can have prism shapes including a polygonal prism, a square prism, a rectangular prism, a triangular prism, a cylinder, a hexagonal prism, and the like. The valves can have a longest dimension (e.g., length, width, diameter) of about 1 mm to 4 mm or about 1 mm to 2.5 mm. The bottom region of each valve can be adjacent to a detection chamber. In an aspect, the top region is closer to the central point of the centrifugal microfluidic device and the bottom region is further away from the central point of the centrifugal microfluidic device than the top region. When the valve is opened by forming an opening in the valve using laser energy, the metering channel associated with the valve and the valve can be in fluidic communication with the detection channel via the opening in the valve. The valves can also include a vent thereby allowing air to exit so that fluid more easily moves into the downstream detection chambers once the valve is opened. The small ‘pseudo-vents’ that can be placed at each valve allow for pressure displacement during fluid distribution, and if some barrier is required that retains fluid but us aur permeable, hydrophobic material can be used to cover the vent outlet.

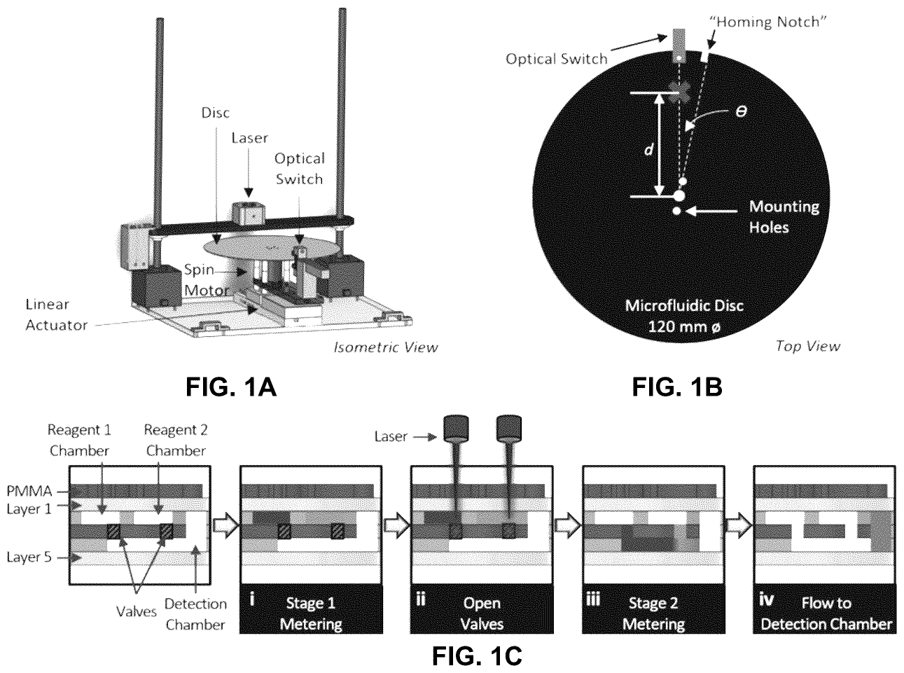

Each valve can be connected to a detection chamber. A detection chamber can be connected to more than one valve (See FIGS. 1C, 16-19). In an aspect, the detection chamber can be populated with a material (e.g., fluid, chemical species, biological species) prior to having a fluid flow into the detection chamber from one or more valves. In an aspect, the detection chamber can have prism shapes including a polygonal prism, a square prism, a rectangular prism, a triangular prism, a cylinder, a hexagonal prism, and the like. The detection chamber can have a longest dimension (e.g., length, width, diameter) of about 1 mm to 10 mm or about 3 mm to 5 mm.

The foregoing description describes various aspects of the sample preparation domain of a centrifugal microfluidic device according to various embodiments of the present disclosure.

As can be appreciated from the depiction of the top view of the full centrifugal microfluidic device in FIG. 2B, there is radial symmetry throughout the centrifugal microfluidic device. For example, all of the valves are positioned at a same radial distance from the center point of the centrifugal microfluidic device in FIG. 2B. This alignment allows for an automated alignment and ablation process when the radial distance and angular position of the valves are programmed into the laser system. The automated valve opening via laser actuation prevents a user from having to manually align the laser with each valve, saving time and adding precision to the system.

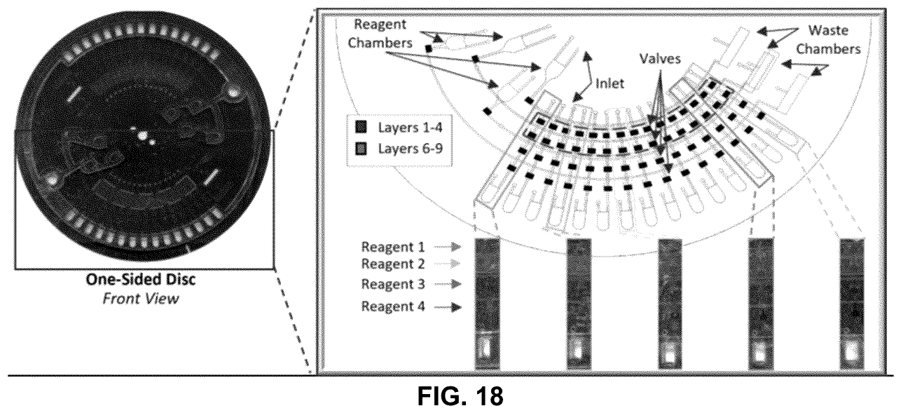

In some examples, portions so the sample preparation domain can be multiplied to allow for two or more reagents. As shown in FIG. 13B, the sample preparation domain can include two reagent chambers with respective distribution channels, networks of metering channels, waste chambers, and sets of valves. A valve for a first reagent and a valve for a second reagent will both connect to the same detection chamber. This multiplication of sample preparation domain element can be conducted further to produce three reagent domains (FIG. 16), four reagent domains (FIG. 18), etc., thus providing a powerful multiplexed microfluidic process. Knowing that as radial distance from the center increases, so does the centrifugal fluid pumping force. In some examples, the valves for one reagent can have the same radial distance from the center of the body of the centrifugal microfluidic device as the valves from a second reagent. In other examples, the valves for one reagent can have a different radial distance from the center of the body of the centrifugal microfluidic device as the valves for a second or third or fourth reagent.

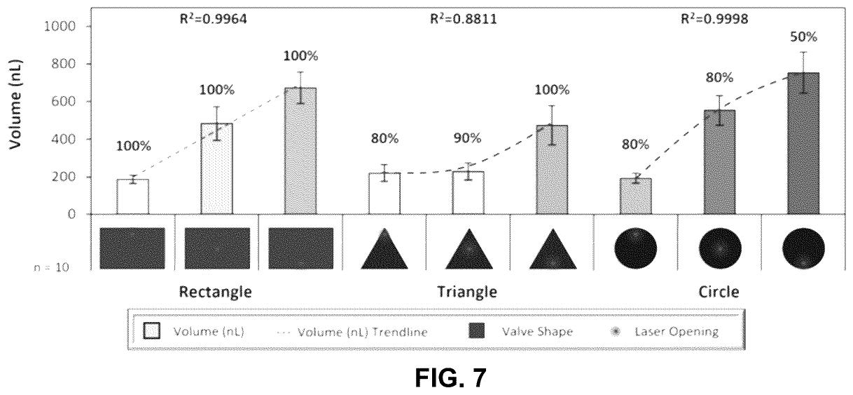

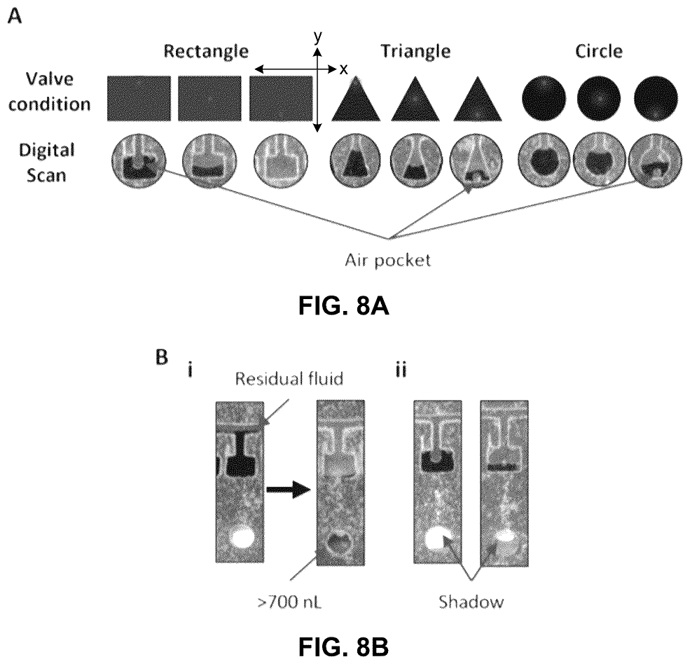

As shown in FIG. 8A, the valves can have prism shapes including a rectangular prism, a triangular prism, and a cylinder. In other words, the respective layer encompassing the valve remains the same, but a cross-sectional shape of the valve can be manipulated to encompass various cross-sectional shapes such as a circle, a triangle, a square, a rectangle, a pentagon, a hexagon, etc. The cross-sectional shape employed by the valve can affect the dispensing of the fluid and the consistency of the metering. The amount of fluid dispensed from the valve is based on the shape of the valve and the location of the laser ablated hole; this is compared in FIG. 7. The rectangular cross-section shaped valve (or alternatively the valve embodying a rectangular shaped valve) provides the most consistent results, showing a linear increase in metered volume dispersed with consecutive laser ablations of the valve at lower increments. The valve of different valve shapes is that is provides fine-tuning options for fluid dispensing. As shown in FIG. 5, the volume dispensed from the rectangularly shaped valve increases linearly with three different puncture locations in the x-direction. This is not the case for a triangularly shaped valve of comparable height, where the volume dispensed from three comparable puncture locations increases dramatically from top to bottom.

The effect of puncture location on the valve on fluid dispensing during two-stage metering is illustrated in FIG. 5. FIG. 5 depicts four metering channel and valve diagrams. The first diagram shows stage one metering with the metering channel and valve full of fluid. The second diagram shows a valve opening near the top region of the valve. Fluid is metered through the valve opening. The volume metered minus the volume retained by the valve equals the volume dispensed as illustrated in FIG. 5. In the third diagram of FIG. 5, the valve opening is in the middle region of the valve. Thus, the volume dispensed in the third diagram is greater than the volume dispensed in the second diagram. Lastly, the fourth diagram shows a valve opening at the bottom region of the valve. Therefore, the volume dispensed is greatest in the fourth diagram. FIG. 5 shows how the volume of dispensed fluid can be manipulated based on placement of the valve opening based on various embodiments of the present disclosure.

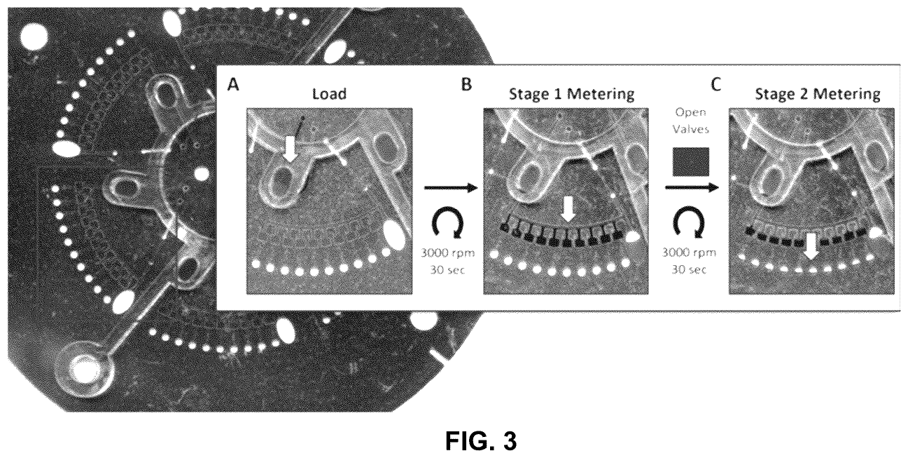

In reference to FIG. 3, shown is exploded images of a sample preparation domain during various stages of a two-stage metering process according to various embodiments of the present disclosure. To begin the process, a fluid is loaded into the reagent chamber via the inlet channel. The reagent chamber is indicated by an arrow in the first picture (A) of the process shown in FIG. 3. In moving from the first step to stage one of the metering process, the device in rotated at a particular speed or frequency (e.g. 1200 rpm=20 Hz). In the example shown in FIG. 3, the device was rotated at 3000rotations per minute for 30 seconds. The centrifugal microfluidic device can be rotated at varying speeds including approximately 500 to 5000 rotations per minute and for approximately 15 seconds to 3 or more minutes. The second picture (B) of FIG. 3 illustrates the metering of the fluid according to various embodiments of the present disclosure. The reagent chamber can now be empty, as shown in the second picture (B) of FIG. 3, as the fluid has been dispensed throughout other portions of the sample preparation domain. The arrow in the picture is pointed to the distribution channel. The now full distribution channel is in fluidic communication with the network of metering channels each filling a valve. The distribution channel can also be in fluidic communication with the waste chamber.

At the end of stage one of metering, the valves are opened via laser ablation and the device is rotated again at 3000 rpm for 30 second, in this example. As with the first rotation, the second rotation can be at varying speeds for varying amounts of time. For example, the device can be rotated at approximately 500 to 5000 rotations per minute for approximately 15 seconds to 3 or more minutes. In some examples, the laser ablation can occur during the rotation. In other examples, the valves can be opened via laser ablation prior to disc rotation.

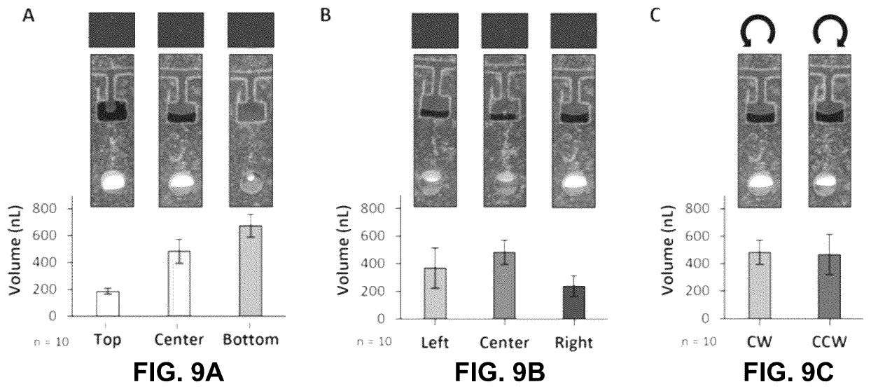

In stage two of the metering process, depicted in the third image (C) of FIG. 3, the opened valves can now be in fluidic communication with the detection chamber via the opening created via the laser ablation. In the example of FIG. 3, the valve opening is in the middle of the valve, therefore the displacement volume is now dispensed into the detection chambers (as indicated by the arrow) and some of the fluid remains in the valve, representing the volume retained. As discussed above, the amount of fluid being dispensed into the detection chamber is based on the location of laser ablation. In various examples, the valve opening can be anywhere on the valve including the middle region, the top region, or the bottom region of the valve. In some examples, this process can be repeated, with the laser ablation location being lowered to disperse more fluid, as illustrated in FIGS. 9A-C. The precision of the laser to create openings at various radial distances from the center and angular positions is depicted in FIG. 6D. The precision of the location of the opening created in the valves allows for the fluid to be aliquoted to an approximate nanoliter volume.

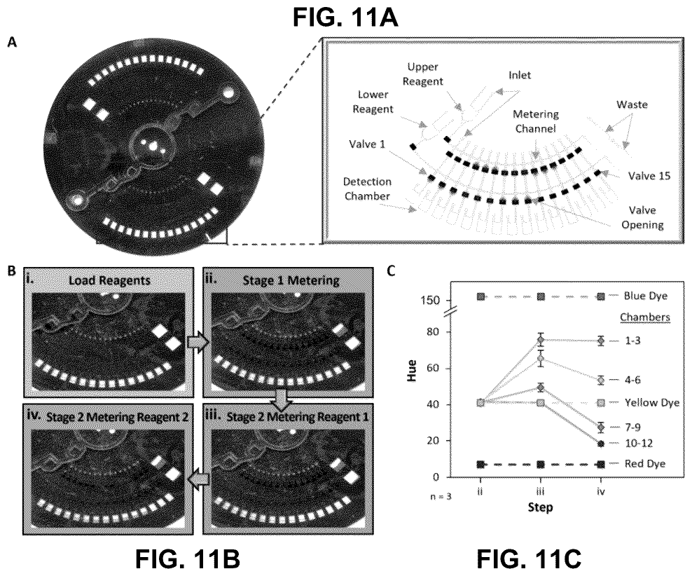

In some examples, the sample preparation domain can be arranged to meter two or more reagents. Two-stage metering of two reagents is illustrated in FIG. 1C. In FIG. 1C, an example of a 5-layer disc is shown from a side view to show two reagent chambers connected to two separate valves. Once the valves are opened via laser ablation, both reagents flow into a single detection chamber. One example of the microfluid architecture of one example of a sample preparation domain where two fluids are metered is shown in FIG. 11A. For example, there can be two reagents with one being an upper reagent chamber and the second being a lower reagent chamber. The sample domain for the upper reagent chamber, or first reagent chamber, can be above the sample domain for the lower reagent chamber, or second reagent chamber, in various examples. The upper reagent sample domain can include a first reagent chamber, a first distribution channel, a first network of metering channels, a first set of valves, and a first waste chamber. The lower reagent sample domain can include a second reagent chamber, a second distribution channel, a second network of metering channels, a second set of valves, and a second waste chamber. The first set of valves and the second set of valves can be in closed connection with detection chambers (e.g., a valve A of the first set of valves and a valve A′ of the second set of valves have closed connection (until opened) with a detection chamber) until the valves are opened created an open connection. Once the upper reagent and the lower reagent reach the detection chamber, the two reagents are mixed in the detection chamber. FIG. 16 shows an example of three reagent metering system and FIG. 18 shows an example of four reagent metering disc according to various embodiments of the present disclosure. The architecture of a three-reagent centrifugal microfluidic device and the architecture of a four-reagent disc can be similarly manipulated as described above with two reagents to increase the architecture to allow for at least four reagents.

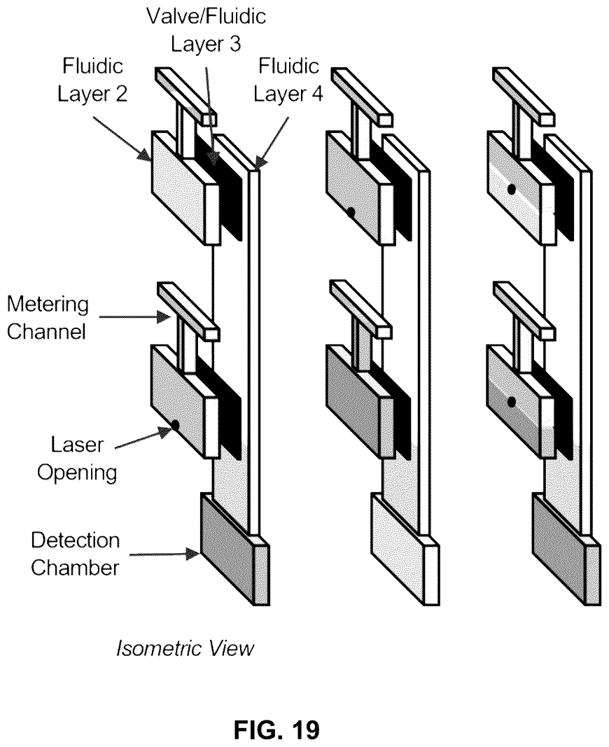

The valves associated with the architecture of the respective reagents in a multi-reagent system can also be opened (punctured) at various locations over the surface area of the valve, thus dispensing varying amounts of fluids. An example of this feature according to various embodiments is shown in FIG. 19. In the first diagram of FIG. 19, the top valve and meter channel is full of fluid and the bottom valve is empty due to a low valve opening completely dispensing all of the fluid from the valve and into the detection chamber located below both valves. Alternatively, in the second diagram in FIG. 19, the top valve is open via a low puncture created by laser ablation. The top fluid is completely dispensed to the detection chamber while the bottom valve remains closed, maintaining all of its fluid. Lastly, the third diagram in FIG. 19, shows both the top valve and the bottom valve with open valves partially distributing both fluids to the detection chamber.

The centrifugal microfluidic device of the present disclosure can enable nanoliter volume of fluid, between 150 nL and 1 μL, to be metered and manipulated with minimal manual intervention. The customizable centrifugal microfluidic disc can conduct multiple reactions in parallel in an automated method. The centrifugal microfluidic device and the method of using the centrifugal microfluidic device is described in more detail in Example 1.

Now having described various aspects and features of the present disclosure, additional features are provided below that cover various features and combination of features that are intended to be described by the present disclosure.

Feature 1: A centrifugal microfluidic device, comprising: a sample preparation domain, comprising: a first reagent chamber; a first distribution channel in fluidic communication with the first reagent chamber; a first network of metering channels furcating from the first distribution channel; a first plurality of valves, with individual valves in fluidic communication with individual metering channels; and a plurality of detection chambers with individual detection chambers connected to individual valves. Feature 2. The centrifugal microfluidic device of any of the features describe herein, wherein individual sample preparation domains further comprise: a waste chamber in fluidic communication with the distribution channel for reagent overflow; and a plurality of vents with individual vents attached to individual valves. Feature 3. The centrifugal microfluidic device of any of the features describe herein, wherein the first plurality of valves are positioned at a same radial distance from a center of the body. Feature 4.The centrifugal microfluidic device of any of the features describe herein, wherein a connection between individual valves and individual detection chambers are closed until an opening is formed in the individual valves via laser-ablation. Feature 5. The centrifugal microfluidic device of any of the features describe herein, wherein individual metering channels are tapered to increase fluidic resistance. Feature 6. The centrifugal microfluidic device of any of the features describe herein, wherein a shape of the first plurality of valves is one of at least: a polygonal prism, a square prism, a rectangular prism; a triangular prism, a cylinder, or a hexagonal prism. Feature 7. The centrifugal microfluidic device of any of the features describe herein, wherein the first reagent chamber has an inlet channel for loading a fluid into the individual sample preparation domains. Feature 8. The centrifugal microfluidic device of any of the features describe herein, wherein the individual sample preparation domains further comprise: a second reagent chamber; a second distribution channel in fluidic communication with the second reagent chamber; a second network of metering channels furcating from the second distribution channel; and a second plurality of valves, wherein individual valves from the first plurality of valves and individual valves from the second plurality of valves both connect to the individual detection chambers. Feature 9. The centrifugal microfluidic device of any of the features describe herein, wherein the individual sample preparation domains further comprise: a third reagent chamber; a third distribution channel in fluidic communication with the third reagent chamber; a third network of metering channels furcating from the third distribution channel; and a third plurality of valves, wherein individual valves from the first plurality of valves, individual valves from the second plurality of valves, and individual valves from the third plurality of valves all connect to the individual detection chambers. Feature 10. The centrifugal microfluidic device of any of the features describe herein, wherein individual metering channels and the individual valve are configured to hold about 100 to 400 nL of a fluid.

Feature 11. A method for metering a fluid, comprising: rotating the centrifugal microfluidic device, rotationally driving the fluid through a network of metering channels and into a plurality of valves, wherein individual valves have a top region adjacent the individual metering channel and a bottom region on the side opposite the individual metering channel; forming a first opening at a first location in individual valves, wherein the first location is in the top region of the individual valve; and rotating the centrifugal microfluidic device, rotationally driving a first specified amount of the fluid from the plurality of valves to a plurality of detection chambers, wherein the first specified amount of the fluid is based at least in part on a radial distance of the first opening of the individual valves and the first location of the first opening. Feature 12. The method of any of the features describe herein, further comprising loading the fluid into a plurality of reagent chambers of a centrifugal microfluidic device. Feature 13.The method of any of the features describe herein, further comprising: forming a second opening at a second location in the individual valves via laser ablation, wherein the second location is below the first location and between the top region and the bottom region; and rotating the centrifugal microfluidic device, rotationally driving a second specified amount of fluid from the plurality of valves to the plurality of detection chambers. Feature 14. The method of any of the features describe herein, further comprising: forming a third opening at a third location in the individual valves via laser ablation, wherein the third location is in the bottom region and is below the second location, wherein the second location is in a region between the first location and the third location; and rotating the centrifugal microfluidic device, rotationally driving a third specified amount of fluid from the plurality of valves to the plurality of detection chambers. Feature 15. The method of any of the features describe herein, wherein the specified amount of the fluid is approximately 100 nL to 1 μL of fluid. Feature 16. The method of any of the features describe herein, wherein individual metering channels and the corresponding individual valve are configured to hold about 100 to 400 nL of a fluid.

Feature 17. A method for metering a plurality of fluids, comprising: loading a first fluid into a first set of reagent chambers of a centrifugal microfluidic device; loading a second fluid into a second set of reagent chambers of the centrifugal microfluidic device; rotating the centrifugal microfluidic device, rotationally driving the first fluid through a first network of metering channels and into a first set of valves and the second fluid through a second network of metering channels and into a second set of valves; forming an opening in individual valves of the first set of valves and the second set of valves; and rotating the centrifugal microfluidic device, rotationally driving a first specified amount of the first fluid from the first set of valves and a second specified amount of the second fluid from the second set of valves to a plurality of detection chambers (in other words, a valve “A ”of the first set of valves and a valve “A” of the second set of valves, once opened, can each flow the first fluid and the second fluid, respectively, into a detection chamber). Feature 18. The method of any of the features describe herein, wherein a radial distance of a first location of the opening in the individual valves of the first set of valves is different from the radial distance of a second location of the opening in the individual valves of the second set of valves. Feature 19. The method of any of the features describe herein, further comprising: loading a third fluid into a third set of reagent chambers of the centrifugal microfluidic device; rotating the centrifugal microfluidic device, rotationally driving the third fluid through a third network of metering channels and into a third set of valves; forming an opening in individual valves of the third set of valves; and rotating the centrifugal microfluidic device, rotationally driving a third specified amount of the third fluid from the third set of valves to a plurality of detection chambers. Feature 20. The method of any of the features describe herein, wherein the plurality of detection chambers contain the first specified amount of the first fluid, the second specified amount of the second fluid, and the third specified amount of the third fluid. Feature 21. The method of any of the features describe herein, further comprising: loading a fourth fluid into a fourth set of reagent chambers of the centrifugal microfluidic device; rotating the centrifugal microfluidic device, rotationally driving the fourth fluid through a fourth network of metering channels and into a fourth set of valves; forming an opening in individual valves of the fourth set of valves; and rotating the centrifugal microfluidic device, rotationally driving a fourth specified amount of the fourth fluid from the fourth set of valves to a plurality of detection chambers. Feature 22 The method of any of the features describe herein, wherein the first specified amount, the second specified amount, the third specified amount, and the fourth specified amount are all different amounts.

Feature 23. A system, comprising a laser; and a centrifugal microfluidic device with a plurality of layers forming a body, wherein the body comprises a plurality of sample preparation domains, individual sample preparation domains comprising: one or more reagent chambers; one or more networks of metering channels furcating from the one or more reagent chambers; one or more sets of a plurality of valves distributed among the one or more networks of metering channels such that individual metering channels fill individual valves; one or more waste chambers connected to the one or more networks of metering channels for reagent overflow; a plurality of detection chambers with individual detection chambers connected to one or more individual valves; and a plurality of vents with individual vents attached to individual valves. 24. The system of any of the features describe herein, wherein the laser is configured to ablate the one or more sets of the plurality of valves creating an opening in individual valves. 25. The system of any of the features describe herein, wherein the plurality of layers forming the body comprises: two or more clear polyethylene terephthalate (PeT) layers; two or more heat sensitive adhesive flanked PeT layers; and one or more optically dense black PeT layer. 26. The system of any of the features describe herein, wherein respective sets of the plurality of valves are positioned at a same radial distance from a center of the body. 27. The system of any of the features describe herein, wherein the one or more networks of metering channels are tapered to increase fluidic resistance. 28. The system of any of the features describe herein, wherein a shape of the one or more sets of the plurality of valves is one of at least: a polygonal prism, a square prism, a rectangular prism, a triangular prism, a cylinder, or a hexagonal prism. 29. The system of any of the features describe herein, wherein the one or more reagent chambers have an inlet channel for loading a fluid into the individual sample preparation domains. 30. The system of any of the features describe herein, wherein the centrifugal microfluidic device is used to perform two-stage metering. 31. The system of any of the features describe herein, further comprising one or more accessory layer placed to increase a fluid volume capacity.

### EXAMPLE 1

### Automated Nanoliter Volume Assay Optimization on a Cost-Effective Microfluidic Disc (also referred to as “centrifugal microfluidic device”)

### Introduction

Since the advent of the miniaturized total analysis (μTAS) concept by Manz and colleagues in the late 1980s, ¹ we have witnessed an evolving capability for performing chemical assays at ever-decreasing volumes. Executing chemical assays at the microliter scale has been eclipsed by microfluidic systems that work effectively in the nanoliter,^{2,3} picoliter,^{4,5} and even femtoliter^{6,7} regimes. However, reports on the manipulation of microliter and nanoliter volumes with combinatorial capability have not been described. This is a critical part of chemical and biochemical assay optimization, where the stepwise change in concentration of any number of reagents must be methodically trialed to identify the ideal conditions for the most effective reaction. For a simple biomolecular chemical reaction, this might be viewed as trivial; for example, when determining the optimal analytical range for visual detection of a drug,⁸ the colorimetric indicator concentration is held constant while the target analyte is titrated over a concentration range, which could be an order of magnitude, to define the color (e.g., RGB, HSB color space) for optimal visual detection. With reactions of a higher order, this becomes exponentially more complex.

This is the case for the amplification of DNA via the polymerase chain reaction (PCR), where optimal amplification involves a ‘reaction mix’ composed of multiple components, including primers, enzymes, and salts, to name a few, that require stepwise adjustment of concentration to yield the most efficient amplification reactions.⁹ Similarly, obtaining strong, quantitative results from an enzyme linked immunosorbent assay (ELISA) requires that the concentration of the sample and detection antibodies are carefully titrated to avoid either saturation or weak/undetectable signal.¹⁰ In a very different application, effective protein crystallization is dependent on ionic strength, precipitant concentration, and, sometimes, the type of detergent to acquire crystals that yield informative diffraction data.¹¹ In each of these cases, an optimized assay requires that a multitude of reagent combinations and permutations be tested. It is not difficult to see that, in the absence of a robotic pipetting station, this leads to a labor-intensive and time-consuming optimization process. Additionally, the cost is significant with some chemistries (e.g., expensive enzymes) or particularly challenging if one of the analytes is of limited availability (e.g., isolated DNA or protein).

Quake's group was the first to show that microfluidics was uniquely poised to address this with minimal manual interaction, applying it directly to protein crystallization.¹² However, the application space in which optimizing reactions in the micro- and nano-liter regime becomes beneficial is vast. Moreover, chemical reaction optimization in much smaller volumes has numerous benefits, including the ability to enhance reaction kinetics by minimizing diffusion and, if needed, microscale architecture that is amenable to parallelization for automation of routine lab workflows with minimal manual intervention.¹³ In terms of nano-volume metering and mixing in microfluidic systems, droplet microfluidics enables creation of nano- and even pico-liter ‘reactors’, but analysis of the reaction products typically requires interrogation ‘in situ’ using sophisticated analytical systems (e.g., fluorescence or mass spec).^{14,15} However, there are more conventional means for performing nanoliter unit operations like metering and mixing, and one of these is centrifugal microfluidics.

Centrifugal microdevices are amenable to different valving methods, including passive valves that rely on passive forces (e.g., pressure, hydrophobic barriers, etc.) and active valves that require external interventions (e.g., heat or laser irradiation), that can combined with judiciously designed architectural features to facilitate fluid transport, mixing, metering, and more.^{16,17} In single-stage metering, fluid fills a metering chamber(s) to a specified volume and excess fluid is diverted into a waste chamber. Two-stage metering performs the same initial single-stage method, but the metered volume can only connect with subsequent fluidic architecture after passing through a valve.¹⁸ With carefully designed microfluidic architecture, these unit operations can be employed to split fluid into sub-1 μL volumes and perform multiple reactions in parallel.

Passive valves have been incorporated into micro-, nano-, and even pico-fluidic devices, as they are simpler to incorporate compared to active valves.¹⁹ Andersson et al. developed a centrifugal microdisc that implemented capillary action to split a volume of fluid into smaller aliquots (stage one) and then into hydrophobic valves (stage two) that could be overcome by centrifugal force, to meter 20-200 nL into parallel reaction architectures.² While this disc was designed to reproducibly perform an impressive 100 reactions simultaneously, hydrophobic barriers were made via local surface modifications that require complex spatial precision and volume deposition. Alternatively, Mark et al. designed a centrifugal PDMS microdisc with a two-stage aliquoting process that incorporated a centrifuge-pneumatic valve, which enabled fluid to flow when the rotational force overcame the counter-pressure of the subsequent channel, to meter 1-36 μL of fluid.¹⁸ More recently, Morikawa et al. developed a glass device for handling picoliter volumes by designing picoliter-sized chambers with strategic geometry to induce capillary pinning, which leverages a large contact angle to prevent fluid flow.⁴ In these examples, the fine architectural features capable of metering and manipulating nano-volumes required costly substrates that were fabricated via lithography, a laborious, time-consuming, and expensive technique.²⁰ While these microdevices could be modified to perform parallel titrations for assay optimization, the cost of the device would likely negate the cost saved by handling reagents at the microscale, and the fabrication methods required are not widely accessible or ideal for rapid prototyping.

Previously, we described the Print, Cut, and Laminate (PCL) fabrication method,²¹ which is amenable to rapid prototyping of cost-effective microdevices as it consumes less than 30 minutes and only requires a laser cutter and standard office laminator to impart architectural features onto inexpensive polymeric materials. Devices created with the PCL method leverage an active valving method based on Garcia-Cordero's optically addressable microvalves,²² but our microdiscs incorporate an optically-dense layer of polyethylene terephthalate (PeT) to create normally-closed valves that can be opened and subsequently closed via laser irradiation to connect and disconnect two fluidic layers.²³

Here, we describe exploitation of the PCL method and these laser-actuated valves as a metering mechanism for sub-microliter volumes of fluid and explore how it can be multiplexed for parallel, cost-effective, and automated assay optimization. The rotationally-driven microdisc incorporates a two-stage metering technique. By tuning the valving strategy (e.g., valve shape, laser irradiation position, and metering architecture), the volume of fluid released to downstream architecture can be carefully controlled for a specific application. The architectural details were subsequently refined for multiple applications, illustrating device use for titration of a drug standard into a colorimetric indicator, parallel titration of primer concentrations in a PCR amplification, and further customizability of the microdevice. This proof-of-concept device permits assay optimization for various applications with a tunable microdevice, requiring very minimal manual intervention thanks to careful consideration of valving strategy and a corresponding external platform that enables automation of on-disc operations.

### II. Methods and Materials

### 1. Microfluidic Device Fabrication

The centrifugal microfluidic discs described herein were constructed using the Print, Cut, and Laminate (PCL) fabrication method.²¹ Briefly, a CO₂ laser (VLS3.50, Universal® Laser Systems, Scottsdale, AZ, USA) was used to ablate architectural features designed in AutoCAD (2019, AutoDesk Inc., San Rafael, CA, USA) into thermoplastic substrates. The core disc was comprised of five layers of 101.6 μM polyethylene terephthalate (PeT) films (Film Source, Inc., Maryland Heights, MO, USA). The clear outer layers (layers 1 and 5) served to enclose the microdevice, while the inner fluidic layers (layers 2 and 4) were coated in a heat sensitive adhesive (HSA; Adhesives Research, Inc. Glen Rock, PA, USA) and separated by an optically dense black PeT (bPeT) layer (layer 3) (Lumirror* X30, Toray Industries, Inc., Chuo-ku, Tokyo, Japan) to permit laser-actuated valving.^{22,23} The individual layers were aligned and passed through an office laminator (UltraLam 250B, Alikes Products Inc., Mira Loma, CA, USA) to create the core device. Laser-cut polymethyl methacrylate (PMMA; 1.5 mm McMaster Carr, Elmhurst, IL, USA) accessory pieces were bonded to the microdevice using pressure sensitive adhesive (PSA; Arcare 7876, Adhesives Research Inc.) to increase select chamber depth, and thus volume.

### 2. Mechatronic Spin System

The custom-built spin system used to generate centrifugal force and perform laser-actuated valving, termed the Power, Time, and Z-Height Adjustable Laser (PrTZAL), is detailed elsewhere.²³ A brushless DC motor (Digi-Key Electronics, MN, USA) with a 3D printed disc mount was connected to a linear motorized translational stage (MTS50-Z8, ThorLabs) that moved in the x-direction (FIG. 1A). A 700 mW 638 nm laser diode (L638P700M, ThorLabs, Inc., Newton, NJ, USA) focused with a collimation tube containing a single aspherical lens element (LTN330-A, Thorlabs, Inc., Newton, NJ, USA) was positioned above the disc via a stage. Targeted microvalves were located and opened by adjusting two variables: the radial distance from the center of rotation (d) and the angle of rotation (θ) relative to a homing notch (FIG. 1B). The positioning of the mounted microfluidic disc relative to the laser was adjusted radially though the translational stage that moved the microdevice in the x-direction with a resolution of 0.04 mm, and the angular positioning was adjusted through the brushless DC micromotor with a 0.2 μ° resolution, a homing notch in the microdisc, and a photointerrupting optical switch (TT Electronics/Optek Technology, Woking, UK). Normally-closed valves were opened via laser irradiation (500 mW, 500 ms) by positioning the laser 15.00 mm above the valve (FIG. 1C). All functions in the PrTZAL system were operated by a 32 bit multiprocessing microcontroller (Propeller P8X32AM44; Propeller Inc., Rockland, CA, USA).

To visually evaluate the accuracy and precision of the PrTZAL system, rectangular valves were opened once or 10 consecutive times at the center of the valve (d=34.4 mm), and the disc was imaged using an Epson Perfection V100 Photo desktop scanner (Seiko Epson Corporation, Suwa, Nagano Prefecture, Japan). Similarly, the radial and angular accuracy/precision was evaluated by opening valves 10 times at different radii (d=33.7, 34.4, 35.1 mm) or at angles that differ ±1° from the center of the valve.

### 3. Optical Analysis of Fluidic Architecture

Optimizing multi reagent assays often requires successive titration of individual components until the optimal combination of conditions is achieved. This process is time consuming, laborious, and often expensive since parallelized experimentation requires bulk consumption of reagents. Microfluidics presents a solution through miniaturization of standard processes by reducing reaction volume, executing multiple parallel workflows, and enabling automation. While single-digit microliter reactions can be effective, scaling to nanoliter volumes without employing droplets is difficult.

Characterization and optimization of microfluidic architecture was performed through on-disc fluidic studies using 0.01 M allura red in 1X TE buffer for visualization. Discs were imaged with the Epson scanner, and images were analyzed using the Fiji distribution of ImageJ software. Specifically, circular regions of interest (ROIs) within each detection chamber were selected following the ‘Crop-Threshold-and-Go’ method described by Woolf et al.²⁴ For pixel count, all pixels outside of the circular 90×90 pixel ROI centered over the detection chamber were cleared and the color threshold was set to an L*a*b* color space with the following thresholding parameters: L*=1-114 pass, a*=141-255 pass, and b*=0-255 pass. Upon selection of the targeted region, the pixel count was measured. A calibration curve correlating pixel count to volume was established by pipetting known volumes, specifically 100-500 nL in 100 nL increments, of the allura red dye into detection chambers and measuring the number of pixels associated with a select volume. The resultant linear trendline (y=5948.5x+293.7; R²=0.9916) was used for determination of volume by inputting the measured pixel count for y and solving for x (nL volume).

For hue analysis, the ‘Crop-and-Go’ method²⁴ was implemented whereby the raw images of the circular 60×60 pixel ROI centered over the detection chambers were converted to a hue-saturation-brightness (HSB) stack to enable hue measurement.

### 4. Characterization of Dual-Stage Metering Workflow

Operation of the microfluidic disc required pipetting 12 μL of 0.01 M allura red dye in 1X TE buffer into the reagent chamber. Following laser-actuated valve opening of the valve directly below the reagent chamber, dye was rotationally-driven into the metering channel and valves (3000 RPM, 30 sec). The array of valves, which were designed to theoretically hold 700 nL, were then opened at specific radii corresponding to either the top, center, or bottom of the valve (d=33.7, 34.4, or 35.1 mm, respectively), and fluid was metered into the detection chambers upon spinning at 3000 RPM for 30 sec. The disc was spun clockwise when 3000 RPM was input into the PrTZAL system and counterclockwise when −3000 RPM was input. Alternatively, valves were opened at specific angles corresponding to the left, center, or right of the valves (angles measured in AutoCAD) prior to metering fluid to the detection chambers.

### 5. Colorimetric Detection and Titration of Illicit Drug

### i. Preparation of Drug Sample and Reagents

Cocaine standard (1 mg/mL, C-008, Cerrilant Corporation, Round Rock, Texas, USA) stored in acetonitrile was hydrolyzed and reconstituted to 10 mg/mL by first aliquoting 25 μL of the standard into 20 0.2 mL PCR tubes (500 μL total). Measures were taken to protect standards from ambient light exposure during preparation. The 20 PCR tubes were nested in 1.5 mL tubes and placed in a vacufuge (Eppendorf Vacufuge 5301, Eppendorf, Hamburg, Germany) for 25 mins at room temperature to remove the organic storage solvent. Upon removal from the vacufuge, samples were placed on ice in a light-tight box, individually reconstituted in 2.5 μL hydrochloric acid (HCl, 10 M; Thermo Fisher Scientific, Waltham, MA, USA), and all 20 PCR tubes were combined for a 50 μL stock solution of cocaine standard with a final concentration of 10 mg/mL.

The cobalt thiocyanate colorimetric indicator, also known as Scott's Reagent, used in this study was prepared according to a protocol described elsewhere.²⁵ Briefly, 2.0 g cobalt (II) thiocyanate was dissolved in 10% acetic acid solution (v/v. acetic acid:water). Hydrochloric acid was diluted to 0.1 M in water. Dye studies were completed with standard food dye added to water.

### ii. Dye Study

The proof-of-concept disc design described previously was adjusted to contain a second array of metering architecture to facilitate addition of two different reagents in 15 separate detection chambers. A mock titration was conducted using water containing either blue, red, or yellow food dye. All were pipetted into the disc, including 2 μL yellow dye into each detection chamber and 15 μL of red and blue dye into the upper and lower reagent chambers, respectively. Upon opening the valves directly under the reagent chambers, the disc was spun at 3000 RPM for 30 seconds to fill the metering architecture. Valves were opened at the top, middle, or bottom of the valve using 33.7 mm, 34.4 mm, or 35.1 mm as the respective radii for the upper array, or using 43.6 mm, 44.3 mm, or 45 mm for the lower array radii, respectively. After opening all valves in the lower array containing blue food dye, the disc was spun at 3000 RPM for 10 seconds in the clockwise and counterclockwise direction to facilitate mixing in the detection chamber. The disc was imaged on an Epson Perfection V100 Photo desktop scanner (Seiko Epson Corporation, Suwa, Nagano Prefecture, Japan) before opening valves to add red food dye to the detection chamber. Upon spinning clockwise and counterclockwise at 3000 RPM for 10 seconds, the disc was scanned and all images were analyzed using the Fiji distribution of ImageJ software. Hue was objectively measured via the ‘Crop-and-Go’ method,²⁴ wherein the raw images of the circular 60×60 pixel ROI centered over the detection chambers were converted to a hue-saturation-brightness (HSB) stack to permit hue measurement.

### iii. Illicit Drug Titration

A titration of drug concentrations was conducted by pipetting 2 μL of cobalt thiocyanate (Thermo Fisher Scientific, Waltham, MA, USA) into each detection chamber. Next, 15 μL of 0.1 M HCl and 15 μL of 10 mg/mL prepared cocaine standard were added to the upper and lower reagent chambers, respectively. Upon opening the valves directly under the reagent chambers, the disc was spun at 3000 RPM for 30 seconds to fill the metering architecture. Valves were opened at pre-defined radii corresponding to the top (upper array: 33.7 mm; lower array: 43.6 mm), middle (upper array: 34.4 mm; lower array: 44.3 mm), or bottom of the valve (upper array: 35.1 mm, lower array: 45 mm) to meter select volumes of reagents in the detection chamber. After opening all valves, the disc was spun at 3000 RPM for 10 seconds in the clockwise and counterclockwise direction to facilitate mixing in the detection chamber. The disc was imaged on an Epson Perfection V100 Photo desktop scanner (Seiko Epson Corporation, Suwa, Nagano Prefecture, Japan) and images were analyzed using the Fiji distribution of ImageJ software to measure hue in the detection chambers following the protocol described above with one additional step: the hue wheel was rotated 127 units to avoid splitting the red between the color spectrum.²⁴

### 6. Primer Titration for PCR

### i. Microdisc Fabrication

The microfluidic disc was adapted to contain four additional core layers, nine in total, to increase the available fluidic architecture and accommodate the titration of four reagents. This thicker microdisc was fabricated via the PCL method using 101.6 μM PeT films (Film Source, Inc., Maryland Heights, MO, USA). The outer layers (layers 1 and 9) enclosed the disc. The inner fluidic layers (layers 2, 4, 6, and 8) were coated with HSA (Adhesives Research, Inc., Glen Rock, PA, USA) to bond layers together; these layers were separated by a layer of optically dense bPeT (Lumirror* X30, Toray Industries, Inc., Chuo-ku, Tokyo, Japan) (layers 3 and 7) to permit valving. An additional middle layer of clear PeT (layer 5) separates architecture on the front and back of the disc, so the reagents from the front flow through layers 2 through 4, while the reagents from the back flow through layers 8 through 6. Layers 3 through 7 were aligned and passed through an office laminator (UltraLam 250B, Alikes Products Inc., Mira Loma, CA, USA) prior to curing in an oven (BINDER GmbH, Tuttlingen, Germany) at 40° C. with 2.83 psi for 1 hour. Afterwards, layers 1, 2, 8, and 9 were then aligned to the top and bottom of the disc, and the device was passed through the office laminator again. The bonded nine-layers were placed in the same oven at 40° C. and 2.83 psi for 16 hours. Laser-cut PMMA accessory pieces were bonded to the top and bottom of the microfluidic disc using PSA (Arcare 7876, Adhesives Research Inc.) to increase the depth and volume of the reagent chambers.

### ii. Dye Study

A mock titration was run on the nine-layer microdevice using water containing either green, blue, yellow, or red dye. Water (2 μL) was pipetted directly into each of the 15 detection chamber, while 20 μL of blue and green dye were pipetted into the upper and lower reagent chambers on the front of the disc, respectively, and 20 μL of red and yellow dye were pipetted into the upper and lower reagent chambers on the back of the disc, respectively. The valves directly under the reagent chambers on the front of the disc were opened, and the blue and green dye were metered across the fluidic architecture by spinning the disc clockwise at 3000 RPM for 10 seconds. Similarly, valves under the reagent chambers on the back of the disc were opened and the disc was spun counterclockwise at 3000 RPM for 10 seconds to fill the metering channels with yellow and red dye. Valves containing green dye in the front lower array were opened at the top, middle, and bottom of the valves using radii values of 43.6, 44.2, and 44.8 mm, respectively. The microfluidic disc was spun clockwise and counterclockwise at 3000 RPM for 10 seconds to drive the green dye into the detection chambers and facilitate mixing between the water and dye. The disc was imaged on an Epson Perfection V100 Photo desktop scanner (Seiko Epson Corporation, Suwa, Nagano Prefecture, Japan) before opening the valves containing blue dye in the front upper array. The radii values used for the top, middle, and bottom of the upper array valves were 33.7, 34.3, and 35 mm, respectively. The disc was spun counterclockwise and clockwise at 3000 RPM for 10 seconds to mix the blue dye in the detection chambers, imaged, and then flipped to expose the architecture on the back of the disc. The same radii values for the upper and lower arrays on the back of the microdevice containing red and yellow dye, respectively, were used. The valves with yellow dye were opened, the disc was spun counterclockwise and clockwise at 3000 RPM for 10 seconds, and the disc was imaged. The same opening, spinning, and imaging process was used for the upper array on the back containing red dye. All images were analyzed using the Fiji distribution of ImageJ software. The raw images were converted to a hue-saturation-brightness (HSB) stack to permit an objective hue measurement via the ‘Crop-and-Go’ method. Because of the extra layers in the nine-layer microdevice, the ROI was changed to a circular 40×40 pixel area to accommodate the increased detection chamber thickness.

### iii. Preparation of Reagents

Plasmid containing the SARS-COV-2 N-gene (Integrated DNA Technologies, Inc., Coralville, lowa, USA) was diluted from 200,000 copies/μL to 20,000 copies/μL by adding 180 μL of nuclease-free water (Mbi GrowCells, Irvine, California, USA) to 20 μL of plasmid. Forward and reverse primers targeting the N-gene (Integrated DNA Technologies, Inc., Coralville, lowa, USA) were reconstituted to 100 μM and aliquots were diluted to obtain a final concentration of 10 μM.

### iv. Primer Titration In-Tube

Master mix for polymerase chain reaction (PCR) was prepared in 0.1 mL PCR strip tubes using 10 μL of Bioline SensiFAST SYBR Lo-ROX Mix (Meridian Biosciences Inc., Cincinnati, Ohio, USA), 1 μL of N-gene plasmid at a concentration of 20,000 copies/μL, varying amounts of forward and reverse primers, and DNA-free water to a final reaction volume of 20 μL. Forward and reverse primers were added at 0.4 μL, 0.8 μL, 1.2 μL, 1.6 μL, and 2.0 μL for final concentrations of 0.2 μM, 0.4 μM, 0.6 μM, 0.8 μM, and 1 μM. Amplification and high resolution melt (HRM) analysis was carried out using a QuantStudio™ 5 (Thermo Fisher Scientific Inc., Waltham, MA, USA). The reaction was held at 95° C. for 2 minutes to activate the polymerase, then cycled between 95° C. for 5 seconds and between 60° C. for 15-30 seconds for 40 cycles. HRM was accomplished by heating the reaction to 95° C. for 1 second, cooling to 55° C. for 20 seconds.

### v. Microfluidic Primer Titration

On the microfluidic disc, 3.6 μL, 3.2 μL, 2.8 μL, 2.4 μL, and 2.0 μL of nuclease-free water were added to detection chambers 1-3, 4-6, 7-9, 10-12, and 13-15, respectively. 20 μL of 10 μM forward primer was added to the front and back upper reagent chambers on the microdisc, while 20 μL of reverse primers was added to the front and back lower reagent chambers. Beginning with the front of the disc, the valves under the upper and lower reagent chamber were opened, and the primers were metered across the fluidic architecture by spinning the disc at 3000 RPM for 10 seconds in the clockwise direction. The valves under the upper and lower reagent chamber on the back of the disc were then opened, and both primers were metered along the back of the disc, again by spinning the disc at 3000 RPM for 10 seconds, counterclockwise. On the front of the disc, chambers 1-3, 4-6, and 7-9 in the lower array were opened at the top, middle, and bottom of the valves using radii distances of 43.6, 44.2, and 44.8 mm, respectively. The front lower valves for chambers 10-12 and 13-15 were opened at the middle and bottom of the valve using distances of 44.2 and 44.8 mm, respectively. To mirror the lower array, the valves in the front upper array were opened at the same valve locations, using different radii: chambers 1-3 were opened at the top, chambers 4-6 and 10-12 were opened in the middle, while chambers 7-9 and 13-15 were opened at the bottom of the valve. The radii distances corresponding to the top, middle and bottom of the valve in the upper array were 33.7, 34.3, and 35 mm, respectively. After opening all valves on the front of the microdevice, the disc was spun at 3000 RPM for 10 seconds in the clockwise and counterclockwise direction. On the back, no valves were opened leading to chambers 1-3, 4-6, or 7-9 to keep the final primer concentrations at 200 μM, 400 μM, and 600 μM, respectively. The valves for chambers 10-12 and 13-15 in both the upper and lower array were opened in the middle of the valve using the aforementioned radii distances to add 0.4 μL of both primers to the detection chambers, making the final concentration of forward and reverse primer 0.8 μM in chambers 10-12, and 1.0 μM in chambers 13-15. After opening all valves on the back of the disc, it was spun at 3000 RPM for 10 seconds in both the clockwise and counterclockwise direction to facilitate mixing of the primers in the detection chambers.

To prepare the PCR master mix for the titrated microfluidic reagents, 100 μL of Bioline SensiFAST SYBR Lo-ROX Mix and 10 μL of DNA-free water was mixed, then 5.5 μL of the mixture was aliquoted into PCR tubes. The 4 μL of fluid in each detection chamber was recovered from the microfluidic disc and added to the PCR reaction tubes containing the aforementioned master mix, and 0.5 μL of 20,000 copies/μL plasmid was added for a total reaction volume of 10 μL. Amplification was conducted on a QuantStudio™ 5 following parameters for PCR and HRM listed previously.

### 7. Fabrication of Expanded Microfluidic Architectures

### i. Six Reagent Disc

A microdisc containing three reagent chambers and three arrays of valves on the front and back was assembled using the PCL method as described previously. Water (2 μL) was added directly into the detection chambers, while 28 μL of yellow, green, and red dye were added to the upper, middle, and lower reagent chambers, respectively. The valves under the reagent chambers were opened using the radii of 32.7, 40.8, and 50.0 mm for the upper, middle, and lower chamber, respectively. The valves in the upper array were opened at the top, middle, and bottom at radii positions of 35.2, 35.7, and 36.2 mm, respectively, while valves for the middle metering channel were opened at the 42.9, 43.4, and 43.9 mm. The valves containing red dye were opened at radii 52.4, 52.9, and 53.4 mm for the top, middle, and bottom, respectively. After opening an array of valves, the disc was spun clockwise and counterclockwise at 3000 RPM for 10 seconds to facilitate mixing.

### ii. 100 Reaction Disc

A microdisc containing two metering channels on the front and back of the disc leading to 100 detection chambers was fabricated as described previously. The PMMA accessory pieces used on the front and back of the disc were 3 mm thick. Yellow dye (2 μL) was pipetted directly into the detection chambers, while 55 μL of red and green dye were added to the upper and lower reagent chambers, respectively. The valves below the upper and lower reagent chamber were opened at radii values of 52.2 and 57.3 mm, and the dyes were metered across the channels to fill the valves by spinning the disc clockwise at 3000 RPM for 10 seconds. The valves in the upper metering channel containing red dye were ablated using radii values of 55.3, 55.8, and 56.3 mm for the top, middle, and bottom of the valve, respectively, while the lower array of valves used 60.2, 60.8, and 61.3 mm radii, respectively. Upon opening valves, the disc was spun clockwise and counterclockwise at 3000 RPM for 10 seconds.

### iii. One-Sided Disc

A microdisc mimicking that used in the primer titration application was designed to have all four reagent chambers and valves accessible from the top of the disc. Two reagent chambers lead to metering channels in layer 2, and two reagent chambers lead to metering architecture in layer 6. The fluidic architecture in layers 6-9 is radially inward of the architecture in layers 2-4, allowing layers 2-4 to be cut to expose the valves in layer 7. Dye was loaded for visualization, and valves in the four metering arrays were opened at the top, middle, and bottom at radii distances of 33.9, 34.4, and 34.9 for the inner-most array (green dye), 38.5, 39.0, and 39.5 for the second array (yellow dye), 43.8, 44.3, and 44.8 for the third array (blue dye), and 49.6, 50.1, and 50.6 for the array closest to the periphery of the disc (red dye). After valves in an array were opened, the disc was spun clockwise and counterclockwise at 3000 RPM for 10 seconds to facilitate mixing.

### 8. Statistical Analysis

Statistical analysis was carried out using Microsoft Excel. Data was analyzed by calculating averages and standard deviations. P values of >0.05 were considered not significant for all T-Tests and one-way or two-way analysis of variance (ANOVA) performed.

### III. Results and Discussion

### 1. Microdisc Design and Operation

The prototype nanoliter metering disc (NMD) shown in FIGS. 2A-B was fabricated via the previously described PCL method,²¹ which allows for complete device fabrication and assembly in under 30 minutes and at an average estimated cost of ˜$1 USD/disc. Each microfluidic device (roughly the size of a standard compact disc) is composed of 5 core layers of laser ablated polymeric materials, including clear polyethylene terephthalate (PeT), an optically-dense black PeT (bPeT), and a heat sensitive adhesive (HSA) for layer bonding (FIG. 2A). PeT layers 1 and 5 served as capping layers, with layer 1 containing sample inlet ports and vents to assure unimpeded flow. Layers 2 and 4 are composed of HSA-flanked PeT and contain the microfluidic architecture. The bPeT layer (3) is critical for active valving, whereby a red laser ablates an ˜80 μm pinhole in a normally-closed sacrificial valve, thus, providing a fluidic connection between architecture in layers 2 and 4. The prototype mechatronic/laser ablation system, also known as the Power, Time, and Z-Height Adjustable Laser (PrTZAL) system,²³ that interfaces with the NMD to facilitate valving. Accessory pieces, made from poly (methyl methacrylate) (PMMA) and capped with PeT, are bonded to the disc through a pressure sensitive adhesive (PSA) to increase chamber volume capacities. Architecture in one representative domain of six identical domains is highlighted in FIG. 2B, which includes a reagent chamber, a metering channel that feeds into the laser-actuated valves, a waste chamber for reagent overflow, and detection chambers.

Initial characterization of the fluidic workflow was performed using dye studies (FIG. 3). The disc was designed to leverage two-stage metering with active valving, whereby at least 10 μL of fluid was manually pipetted into the reagent chamber (FIG. 3) and rotationally-driven into a connected network of 10 downstream metering channels containing corresponding sacrificial valves (FIG. 3). Upon device rotation, each valve theoretically holds ˜500 nL of fluid, with an additional 200 nL being retained in the upstream channel; any excess reagent was driven to the waste chamber. Stage 2 metering involves laser-ablating the sacrificial valves open, then rotationally-driving fluid into downstream detection chambers (FIG. 3). The rectangular valves were opened in the center through an automated alignment/ablation process, whereby the radial distance and angular position of the valve was programmed into the corresponding PrTZAL system (FIGS. 1A-C), along with order of operations and rotational directions (e.g., speed and time).

Multiple architectural features were implemented to ensure reagents flowed as intended. First, valves were positioned at the same radial distance from the center to allow for automation of valve opening. This spared the user from having to manually align the laser with each valve, which can consume a significant amount of time and increase issues associated with inter-operator variability. Second, the metering channel was tapered to increase fluidic resistance, forcing fluid to fill the metering chambers prior to driving fluid to the waste chamber. Third, a ‘pseudo-vent’ was added to layer 2 by cutting a 100 μm wide slit to the upper left corner of each valve, allowing fluid to move more easily into downstream detection chambers. Use of a traditional vent (illustrated in reagent and waste chambers in FIG. 2B) was not possible because of the narrow proximity of metering architecture; however, the small volume of fluid requires pressure displacement beyond the capability of the system (e.g., below 3000 RPM), thus, a pseudo-vent was necessary.¹⁶

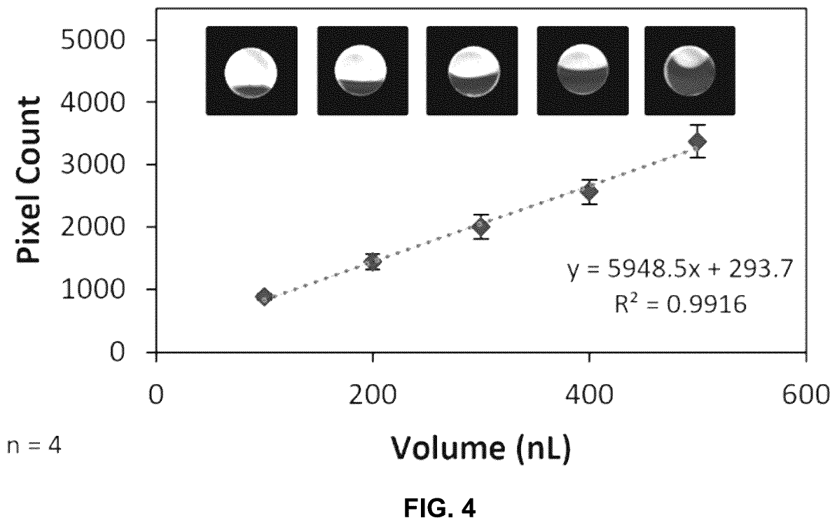

Quantitative image analysis was used to characterize this iteration of the metering design, along with aqueous red dye for visualization. Scanned images of cropped detection chambers were analyzed for fluid volume using the color thresholding method.²⁴ A calibration curve was established to measure the pixel count of red dye in detection chambers containing known volumes fluid volumes from 100-500 nL (FIG. 4). The results indicate a linear trend (y=5948.5x+293.7; R2=0.9916), and subsequent work extrapolated dispensed volumes from this trendline.

### 2. Optimization and Characterization of Two-Stage Metering

The concept behind this form of dual-stage metering relies on aliquoting <1 μL into the metering channels and valves in stage 1 and changing the position of the valve opening to tune the fluid volume dispensed into downstream architecture. FIG. 5 illustrates a valve filled during stage 1 metering, with stage 2 metering occurring after the valve is opened at the top, center, or bottom of the valve. Equation 1 formulates this theory: the final volume dispensed from the valve (Vol_{disp}) is determined by subtracting the volume retained (Volᵣₑₜ) in the valve post-laser actuation from the initial volume metered (Volₘₑₜ) in stage 1.

Vol_{disp}=Volₘₑₜ−Volᵣₑₜ (1)

It was hypothesized that opening the valve near the top would result in the minor fraction of the total fluid being expelled during disc rotation. Conversely, valving at the bottom would potentially enable maximum expulsion of fluid. With this NMD design, four variables contribute to the reproducibility and metering tunability: (1) the accuracy and precision of the PrTZAL instrument, (2) the valve shape, (3) the location of valve opening, and (4) the architecture upstream of the valve. Each of these variables were evaluated in terms of impact on the fluid volume metered to detection chambers in the second stage, with reproducibility determined by completing ten valving events.

### i. Instrumental Accuracy and Precision

The preferred valve shape to-date has been rectangular, and the location of the 80 μm ablated valve opening was defined by radial and angular coordinates input into the PrTZAL software. For all of our previous applications, the ablated opening was simply a port between fluidic layers, and the exact position of that ablated hole was always inconsequential, owing to the fact that the volume of fluid traversing the valve was larger (by orders of magnitude) than the valve volume itself. However, when considering exploiting this system for nanoliter volume metering, the location of the opening matters, as does the volume of valve itself. Since the radial position of the opening determines the volume of fluid dispensed from (Vol_{disp}) and retained by (Volᵣₑₜ) the valve, the reproducibility in hitting repetitive coordinates needed to be evaluated. Holding the opening location constant, valves were opened with either a single firing of the laser (FIG. 6A) or with 10 repeat firings (FIG. 6B), then imaged. FIG. 6C illustrates the accuracy and precision of a single (FIG. 6C(i)) and consecutive (FIG. 6C(ii)) valve openings in the center of the valve. To test the radial accuracy, the angular coordinate was held constant, but the radial changed to open the valves at the top, center, and bottom (FIG. 6D(i)); the angular reproducibility was tested in a similar manner (i.e., left, center, right) (FIG. 6D(ii)). When comparing the single to the consecutive valve openings, the single fire openings are clean and small, and these openings look dramatically different to holes created with multiple firing. First, repetitive exposure to heat from repeated laser firing caused the size of the hole to expand significantly, although inherent error in the PrTZAL system hardware can't be ruled out as the radial error (linear actuator) is 0.04 mm, and the angular error (brushless motor for disc rotation) is roughly 0.2°.²³ Second, a small, raised ridge, or burr, can be seen around the edge of the larger holes, likely from ablated bPeT debris. Overall, the consistency of the valve opening shape upon repetitive (n=10) laser firing is indicative of the high accuracy and high precision of the PrTZAL instrument.

### ii. The Effect of Valve Shape on Metering

After examining the repeatability of hitting the same coordinates, we explored the relationship between valve shape and volume metered. Discs were fabricated with 6 domains containing 10 rectangular, triangular, or circular valves per domain that were opened at different radial locations—top, center, or bottom (FIG. 7). For consistency, the dimensions of the metering channel leading to the valve was held constant while the area of the valve was adjusted to ensure the metering chambers retained the same volume (700 nL). In testing, both the Vol_{disp} and the frequency of successful valve openings (%) were evaluated to determine which shape resulted in the smallest volume of fluid metered and the most reproducible valving.

FIG. 7 depicts the average Vol_{disp} to the detection chamber across all 10 valves. Generally, as the valve opening is shifted radially downward, the amount of fluid expelled to the detection chamber increases as Volᵣₑₜ fluid decreases. Depending on the location, the rectangular valves metered an average Vol_{disp} of 186.5 nL±23.3 nL (top), 484.5 nL±89.2 nL (center), and 674.4 nL±84.8 nL (bottom), illustrating a linear increase in metered volume. This was unsurprising given the symmetry of the rectangular shape, which allows the Vol_{disp} to increase by equal amounts when changing radii. Conversely, the triangle valve resulted in 220.0 nL±46.2 nL, 228.4 nL±45.5 nL, and 474.9 nL±105.7 nL (top, center, bottom, respectively) of fluid metered. This exponential increase in volume as the valve opening moved towards the bottom was logical since opening the valve at the top versus center does not significantly change the Vol_{disp}, but valving at the bottom allows the full volume of fluid to be dispensed. Finally, the circular valve dispensed an average of 192.3 nL±27.7 nL, 553.7nL±78.4 nL, and 754.5 nL±109.7 nL (top, center, bottom, respectively). The logarithmic increase (top to bottom) in Vol_{disp} is understandable as the valve width is narrower at the top and bottom relative to that in center; similarly, the Vol_{disp} was not expected to increase significantly when opening at the bottom relative to the center condition. Generally, when the valve is opening at the top position, there is no shape dependence, i.e., no statistical difference in the average volume metered to the detection chamber (one-way ANOVA: p-value=0.110, α=0.05) as only the fluid in the channel leading to the valve was dispensed. Conversely, when valves were opened at the lowest radial position, rectangular and circular valves dispensed a similar volume (unpaired T-Test: p-value=0.140, α=0.05), but the triangular valve had a lower Vol_{disp}; this resulted from fluid being trapped in the acute corners of the valve, a consequence of air expanding as the laser ablated a hole in the valve (FIG. 8A). Together, these findings indicate that either the circular or rectangular valves could be used, as they reproducibly dispensed approximately 200, 400, and 600 nL (top, center, and bottom, respectively).

It is worth noting that while the metering chamber held a theoretical volume of 700 nL, a Vol_{disp} of greater than 700 nL was infrequently observed regardless of valve shape. One possible cause was the minute volume of residual fluid in the metering channel flowing through the open valve. This phenomenon was typically avoided by spinning the disc again if residual fluid was visualized in the metering channels. Another, more likely, cause of an overestimation of recovered fluid is related to the presence of shadows in the scanned image of the detection chamber, which slightly skew the estimated pixel count during the thresholding portion of image analysis (FIG. 8B).²⁴ The latter is unavoidable as thresholding parameters were set to keep image analysis objective. Unfortunately, this increased the standard deviation when averaging Vol_{disp}, particularly when larger fluid volumes were estimated to be recovered.

To select a final valve shape, the shape-dependent success rate for valve opening was assessed (FIG. 8A). Rectangular valves were the most reproducible with 100% of valve opened at all positions. Triangular valves were less consistent with opening success rates of 80% (top), 90% (center), and 100% (bottom). The circular valves showed the poorest reproducibility with 80% (top), 80% (center), and 50% (bottom). The failure mode for valve opening generally resulted from slight misalignment of the PrTZAL system due to instrumental error, resulting in either an opening on the edge of the valve, causing ablated material to block the fluid from the hole, or firing outside of the valve target area entirely. A sub-100% valve opening was not surprising with the triangular valves at the top or center radial positions, or with the circular valves at the top and bottom positions, as those geometries have small margins for error in angular accuracy compared to the rectangular valve. These results demonstrated that the rectangular valves compensated for the limitations of the external laser system, and thus, were selected for all further experiments.

### iii. Radial and Angular Accuracy

Having selected rectangular valves, characterization of the radial and angular accuracy was examined through dye studies with the metric being V_{disp}. As previously discussed, the fluidic V_{disp} with opening at the top, middle, and bottom were 186.5 nL±23.3 nL, 484.5 nL±89.2 nL, and 674.4 nL±84.8 nL, respectively (one-way ANOVA: p-value<0.05E-12, α=0.05), and a visual representation depicting one representative example from each valve opening parameter is shown in FIG. 9A for reference. To assess the angular accuracy of the system relative to the microdevice, rectangular valves were opened in the radial center position and the angle of the valve was adjusted ±1.0° to open the valve in the angular left, center, and right position of the valve (FIG. 9B). There was no statistical difference in the volume of fluid metered between the left and center conditions (left=368.9 nL±146.3 nL; center=484.5 nL±89.2 nL; T-Test: p-value=0.080, α=0.05) or between the left and right conditions (right =239.2 nL +76.0 nL; T-Test: p-value=0.051, α=0.05); however, significant variability in the V_{disp} was seen when comparing the center and right valve openings (T-Test: p-value=0.00007, α=0.05). An increased standard deviation was observed when opening in the left and right positions due to the innate angular error associated with the PrTZAL system. Opening in the center of the valve allowed slightly more fluid to be dispensed as the center of the meniscus formed by fluid retained in the valve aligned with the valve opening. The right valve opening had the smallest V_{disp}; this was due to the default counterclockwise direction of rotation that imparts a Coriolis force¹⁹ towards the left wall of the valve, ultimately pushing fluid to the left and allowing only a fraction of the dye to go through the hole near the right wall.

Coriolis force can be significant in centrifugal systems, potentially altering the Voldisp; this motivated us to explore the effect of rotational direction. Results in FIG. 9C indicate there was no statistical difference based on clockwise (CW) or counter-clockwise (CCW) spinning when valves were opened in the radial and angular center. Following previous observations (FIG. 9B), we concluded this was the result of the meniscus aligning with the valve opening in the center, and had the valve opening been adjusted by a degree to either side, the direction of rotation would be expected to impact the volume of fluid metered.

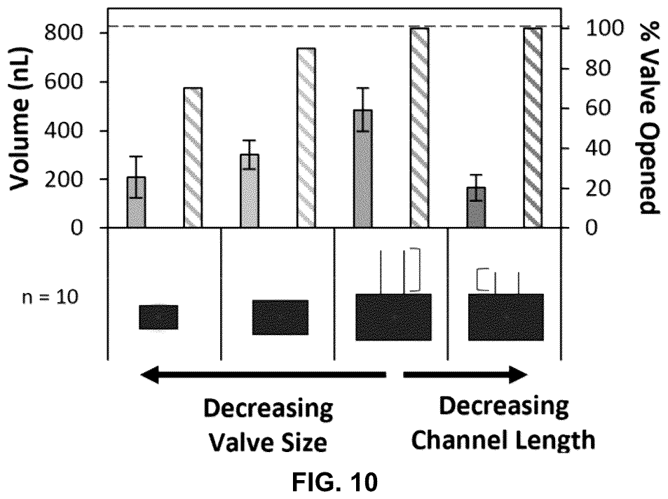

Finally, to query whether a reduction in the valve size and inlet channel length would further decrease the Vol_{disp}, the total area of the valve was reduced to 50% and 25% of the original dimensions, and this led to volumes of 301.5 nL±58.3 nL and 209.1 nL±83.9 nL, respectively (FIG. 10). With the valves opened in the radial and angular center, theoretically, reduction in the valve size, combined with adjusting the position of the valve opening, could enable metering to 100 nL or lower. However, the success rate for valve opening decreased to 90% and 70% as the area decreased (to 50% and 25%, respectively); this was not unexpected based on the error associated with the PrTZAL instrument. Alternatively, using the standard valve size but reducing the channel length leading to the valve by 50% allowed for 167.5 nL±52.5 nL to be metered. This volume was statistically similar to the lowest volume achieved by reducing the valve area to 25% of the original (T-Test: p-value=0.207, α=0.05) but with a valve opening success rate of 100%. While this information did not impact architectural changes for applications discussed in this paper, it was useful data to develop a bank of information from which to “tune” this device for future studies.

### 3. An application in Illicit Drug Titration

The testing of controlled dangerous substances (CDS) in forensic laboratories often requires some amount of the CDS sample to be consumed by presumptive, colorimetric testing to affirm the presence of a drug before an analyst can move on with confirmatory testing, such as mass spectrometry. However, there may be some cases in which the collected sample is limited and does not permit both presumptive and confirmatory testing. Here, we show the proof-of-concept application of our titration device to automate the presumptive testing of cocaine while minimizing the amount of diluted cocaine required for such testing.

The idea here is to mimic two-unit operations, including dilution of the drug and downstream detection via a colorimetric indicator solution. For this application, fluidic architecture was adjusted and a dye study was completed. FIG. 11A shows the modified microdisc, which includes a second reagent chamber, additional metering architecture, and an additional waste chamber positioned closer to the periphery of the disc (FIG. 11A). The detection chamber shape was altered from a circle to a square, large enough to accommodate at least 10 μL, and vents were added to facilitate fluid flow; all other design/architecture remained the same.

Functionality of the modified architecture was assessed using dye studies with red dye representing the diluent, blue dye the presumed illicit drug, and yellow dye the colorimetric indicator. Red and blue dye were loaded into the upper and lower reagent chambers, respectively, with yellow dye pipetted into the detection chambers through the inlet (FIG. 11B(i)). The valves directly below the reagent chambers were opened and fluid was metered via centrifugation (FIG. 11B(ii)). Valves containing blue dye were opened according to the FIG. 11A and spun into the detection chamber (FIG. 11B(iii)) prior to opening valves containing the red dye (FIG. 11B(iv)). Valves were opened at the top, middle, or bottom of the two valve arrays to facilitate a titration with the total volume of fluid metered to the detection chambers remaining constant. Although color change in the chambers was visually apparent, ambient lighting as well as variability of human interpretation yields a subjective analysis prone to error²⁴, hence, objective image analysis with scanned images was carried out. Using hue, a circular variable that represents a color within the visible region of the electromagnetic spectrum, to measure resultant dye in each detection chamber provided empirical analysis that confirmed the visual observations. As blue dye was added to chambers containing yellow dye, hue shifted towards a green color, and as varying volumes of red dye were metered, the hue shifted to five distinct colors (single-factor ANOVA: p-value=1.56E-10, α=0.05) (FIG. 11C). Objective volume quantification confirmed chambers 1-3 had a green hue as ˜600 nL of blue dye was added to the yellow dye in the detection chambers. Similarly, chambers 4-6 contained ˜400 nL blue dye and ˜200 nL red dye in the starting yellow dye, resulting in a yellow-green color, whereas chambers 7-9 contained only ˜200 nL blue dye and ˜400 nL red dye, thus, the final hue was closer to orange-yellow. Finally, chamber 10-12 only had ˜600 nL red dye added to the initial yellow dye, creating a red-orange hue. These findings demonstrate application of the two-stage metering to an adapted disc design where nano-volumes were successfully added to the detection chambers with more consistency than would be possible with manual pipetting.

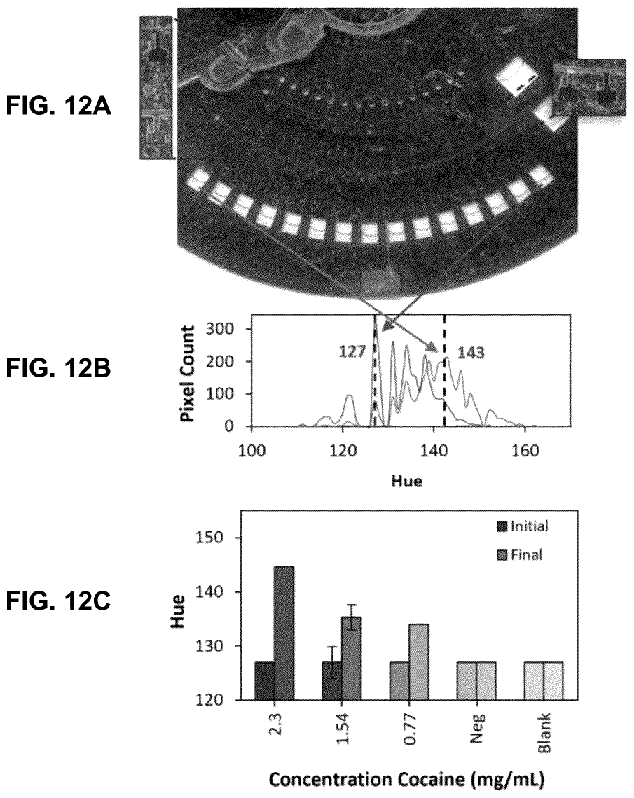

FIG. 12A-C shows utilization of the same disc and same two-stage metering applied to presumptive testing of a cocaine; here, hydrochloric acid (HCl) is the diluent and Scott's reagent (cobalt (II) thiocyanate) is a colorimetric indicator used in routine forensic CDS analysis that changes from a pink hue to a blue-colored coordination complex in the presence of cocaine.²⁶ The cocaine standard that was originally 1 mg/mL was hydrolyzed to remove the acetonitrile as working with organic solvents in the microdevice can cause unnecessary complications, and higher concentrations of the drug were preferred for this study. The cocaine standard was reconstituted in HCl to a final concentration of 10 mg/mL; this predilution concentration is relevant, as the threshold for toxic levels of cocaine in the blood is around 1 mg/ml.²⁷ The diluent (HCl) was pipetted into the upper reagent chamber, drug into the lower reagent chamber, and cobalt (II) thiocyanate into the detection chambers.

FIG. 12A shows the disc after reagents were metered with exploded views depicting valves opened at differing radial positions and, thus, retaining dissimilar volumes of fluid. When viewing the fluid in the chambers from left to right, the left-most chamber contained the highest volume of cocaine (˜600 nL) with no diluent, thus exhibiting a final blue color with a mode hue of 143 (FIG. 12B). Moving right, drug added to the detection chambers became more dilute with chambers on the far right representing the blank condition. Results comparing the hue of all detection chambers before and after the drug titration indicate a statistical difference between the initial and final hue (two-factor ANOVA: p-value=2.75E-9, α=0.05) (FIG. 12C). Conversely, there was no difference in initial and final hue between the negative controls, which had only diluent metered, or the blank chambers containing only indicator. Additionally, there was a significant difference in the final hue of all concentrations, except for 1.54 mg/mL and 0.77 mg/ml (Paired T-Test: p-value=0.422, α=0.05), which was expected as this is the lower limit of analytical testing for the indicator,²⁶ and the control conditions. Here, the microfluidic titration of drugs enabled metering of sample in the nanoliter-range with minimal human intervention.

### 4. Primer Titration for PCR Optimization

PCR amplification of DNA is the workhorse of modern molecular biology, and while efficient in creating >1 billion copies of DNA from a single copy of template, optimization can be challenging owing to the number of components in the reaction. The concentrations of PCR components, including primers, enzyme, salts, and nucleotides, are critical to achieving efficient amplification. For primers, the desired concentration is typically ˜10% of the total reaction volume; thus, for a 20 μL reaction, primers are added in the hundreds of nanoliters range. Moreover, the concentration of the forward and reverse primers may be different, requiring a series of reactions covering the desired primer concentration(s) to optimize PCR chemistry, which can be time-and labor-intensive and consume expensive reagents. Here, we customize a microdisc to provide functional, automated titration of both forward and reverse primers in a PCR assay.

To accommodate the number of chambers necessary to facilitate a multi-reagent titration without increasing the disc size, additional fluidic layers had to be added to the disc. A nine-layer NMD was PCL fabricated using PeT, bPeT, HSA, and PMMA (FIG. 13A). The four disc layers above layer 5 (i.e., the ‘top’ side) are a mirror image of the four below (i.e., the ‘flip’ side). While not ideal, the added manual step of flipping the disc to access architecture on the flip side effectively doubles the fluidic architecture, and thus, the number of reagents that can be metered in the disc while maintaining disc size. Microfluidic layers with laser-cut microchannels (2, 4, 6, and 8) were cut in clear PeT/HSA while the laser-actuated valving was in bPeT layers (3 and 7). Note that in FIG. 13A the architectural features on the corresponding layers above and below layer 5 overlap, including the valves; hence, it was critical to establish that opening a valve in layer 3 did not open the corresponding valve in layer 7 to ensure both sides of the disc could be used independently. This valve opening process was depth-specific for two reasons: first, the focal distance between laser of bPeT surface was carefully controlled, and second, we believe that having fluid in the valve prior to opening acts as a heat sink, dissipating the thermal energy and preventing the opening of overlapping valves. Bonded to layers 1 and 9 were PMMA accessory pieces that served to increase the volume in the reagent and detection chambers. The accessory PMMA piece on the top side increases the volume of the reagent and the detection chambers, while that on the flip side only encapsulates the reagent chambers. This asymmetrical design was purposeful as the PMMA allowed for easier fluid recovery from the detection chambers via the top side while enabling image analysis to be conducted using scanned images of the flip side without the disruption of shadows from PMMA. The architecture in any single domain on this disc was similar to that used for the drug titration application, with the main difference being that both the top and flip side have architecture for two-stage metering (FIG. 13B).

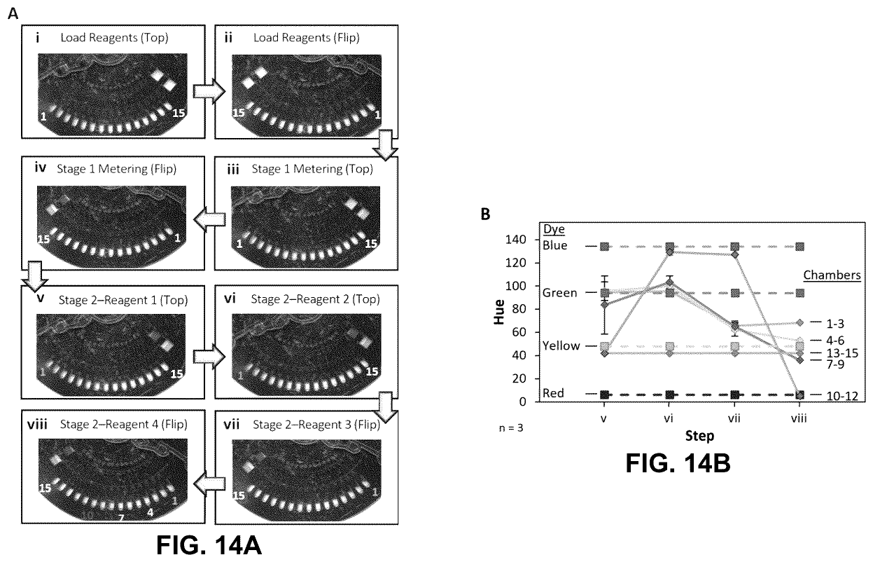

To ensure functionality in the combinatorial titrating of four reagents in parallel into the detection chambers, a dye study was carried out using standard food dyes diluted in water (FIG. 14A). As proven in FIGS. 9A-C, rectangular valves opened at different radial positions (top/center/bottom) provide a predictable metered volume that is delivered to a downstream chamber. To put this into practice, we tested the ability to create a hue gradient across detection chambers by valving at the top, center, or bottom of the valves in the upper and lower arrays, on both the top and flip sides of the disc. The resulting color change in the detection chambers was apparent to the naked eye, but objective colorimetric analysis was performed on scanned images of the disc using ImageJ to define hue values for the detection chambers at different steps in the metering process (FIG. 14B). Stock green, blue, red, and yellow dyes, with respective hue values of 94, 134, 48, and 6, were sequentially metered into the detection chambers. With the addition of each dye, the empirical hue value shifted toward that of value of the stock dye: chambers containing green dye exhibited a shift in hue from 94 toward 134 as blue dye was added. Similarly, hue decreased towards 48, then 6 as yellow and red dye were added, respectively. Specifically, chambers 1-3 had an estimated 600 μL of green dye and 600 μL of yellow dye added to the detection chamber, without any blue or red dye, creating a yellow-green hue. Chambers 4-6 shifted from green to teal to yellow-green to a dark yellow-green as 400 μL of green dye, 200 μL of blue dye, 400 μL of yellow dye, and 200 μL of red dye was added. Chambers 7-9 had a similar hue shift although the final color was more orange, since 200 μL green dye, 400 μL blue dye, 200 μL of yellow dye, and 400 μL of red dye was added. Chambers 10-12 transitioned from clear to blue to red as 600 μL of blue dye then 600 μL of red dye was added, creating a red-purple hue in the chambers, while chambers 13-15 were a control with only water present. After metering the final dye, the hue in the detection chambers had shifted into five distinct colors (single-factor ANOVA: p-value=7.71E-10, α=0.05). These findings demonstrate that the two-stage metering applied to the nine-layer microfluidic disc, wherein 4 reagents are titrated via 45 valves into 15 detection chambers, provided excellent, autonomous, combinatorial metering with high consistency and precision.

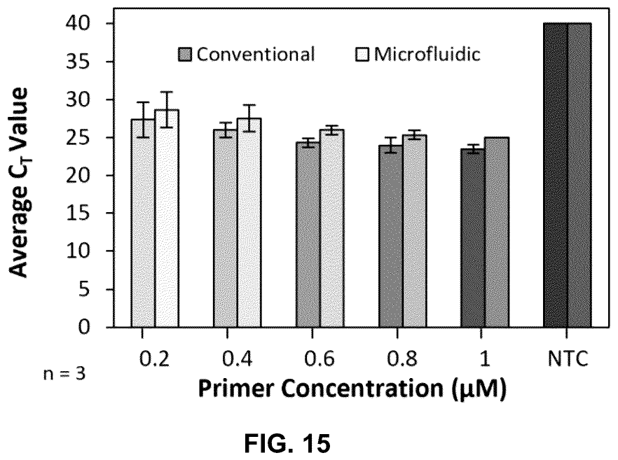

Having demonstrated metering with dyes, we transitioned to an application where reagents are precious and smaller volumes more economical. The effective amplification of sequence specific for the N-gene of SARS-COV-2 involves optimizing the concentration of primers employed in the assay. The forward and reverse primers were titrated with half-volume reactions on the NMD while parallel titration reactions were prepared in-tube using full-volume reactions. The recommended PCR master mix primer concentration is 0.4 μM in a 20 μL reaction. To avoid non-specific amplification, optimization routinely involves titrating both the forward and reverse primers over a range of 0.1 μM-1 μM. On-disc primer titration for half-volume reactions (10 μL) was executed with the appropriate spin protocol and fluid was recovered from the detection chambers prior to mixing with master mix. Reagents were prepared in parallel using conventional in-tube methods, and all reactions were amplified simultaneously via quantitative PCR (qPCR). FIG. 15 compares the average cycle threshold (CT) values for the conventional in-tube PCR reactions to the reactions prepared via microfluidic titration. CT values from conventional analysis were quantified at 27.3±2.3, 26±1.0, 24.3±0.5, 24.0±1.0, and 23.5±1.2 for primer concentrations of 0.2, 0.4, 0.6, 0.8, and 1 μM, respectively. Average CT values for the microfluidic approach were 28.7±2.31, 27.5±1.73, 26.3±0.58, 25.3±0.58, and 25.0±0.00 for primer concentrations of 0.2, 0.4, 0.6, 0.8, and 1 μM, respectively. The non-template controls (NTC) did not amplify within 40 cycles under either condition. Both methods resulted in the same trend: as primer concentration increased, the C_{T} values decreased a significantly, indicating more efficient reactions with 1 μM primers (Conventional single-factor ANOVA: p-value=0.018, α=0.05; Microfluidic single-factor ANOVA: p-value=0.047, α=0.05). The C_{T} values between the conventional and microfluidic method were statistically significant (two-way ANOVA: p-value=0.0059, α=0.05), which was expected; however, the microfluidic results differed from the conventional by <1 C_{T}, indicating that PCR efficiency was not adversely affected when full (conventional) was compared to half (microfluidic) reactions. Furthermore, the microfluidic titration of primers reduced reagent consumption by 50%, ultimately lowering the associated cost, assay setup time, and resources needed to perform primer titrations.

### 5. Nanoliter Metering Disc Customizability

Having illustrated the applicability of the two-stage metering technique on the NMD, it was critical to demonstrate the customizability of the microfluidic architecture to enable a broader range of applications. Increasing the number of reagent and detection chambers enhances the utility for multiplex titration that may be required for more complex reactions. As a proof-of-concept, a six-reagent NMD was fabricated using the same nine-layer construction illustrated for the primer titrations. Each domain of the two-domain disc contained 26 detection chambers to handle the combinatorial titration of six reagents, 3 on each of the top and flip sides (FIG. 16). This multiplexed architecture can facilitate the automated titration of multiple components of PCR (e.g., salts, enzymes, forward primer and reverse primer, buffers, etc.) in tandem, circumventing the amount of conventional pipetting into PCR tubes. A preliminary dye study was conducted to demonstrate the utility of this disc.

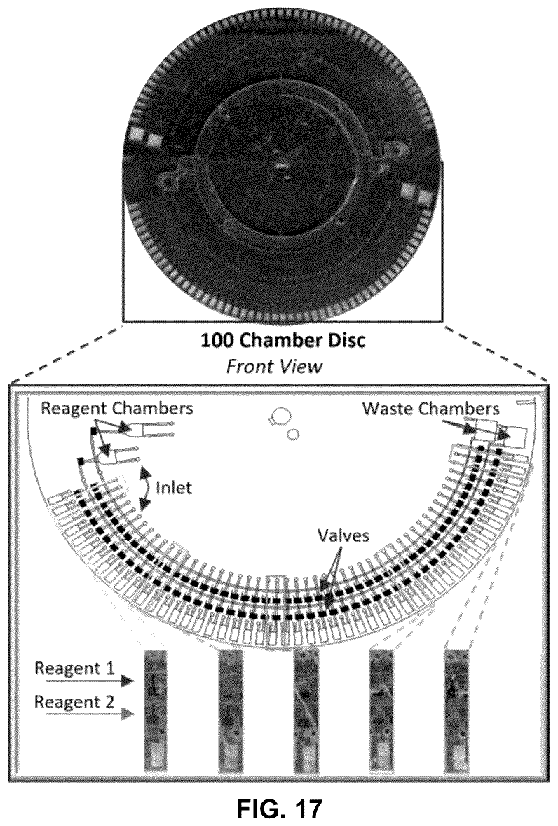

Convinced that this did not represent the full potential of the NMD, and fully aware that the limitation was likely fabrication, we fabricated a two-domain microfluidic disc with 100 detection chambers. Each domain contained 50 detection chambers and two reagent chambers on both sides of the disc, thus, allowing for the titration of four reagents (FIG. 17). It is important to note the thickness of the accessory PMMA pieces bonded to the front and back of the disc was 3 mm, twice that of the other nine-layered discs to account for the increased reagent volumes needed to fill all 50 reaction chambers. This microdevice can titrate multiple assay components and/or perform a standard curve dilution in one domain while analyzing a reagent of an unknown concentration in the other domain, reducing inter-batch differences and standardizing experimental conditions. The modified design includes space near the center of the disc for incorporation of additional analytical processes, e.g., sample preparation, upstream of the detection chambers.

Finally, we recognize that having to manually flip the disc mid-experiment to open valves on the flip side of the disc was not pragmatic and excludes automating the assay. However, this was done solely to illustrate that enhanced capability and capacity could be built into the system without increasing the microfluidic footprint. With the 9-layer disc design used for the PCR primer titrations, the manual intervention could be mitigated with a few design modifications: all reagent chambers were positioned on the top of the disc, and layers 2-4 were cut through to expose the valves on layer 7 which can then be opened from the top side of the disc (FIG. 18). The metering arrays and waste chambers were adjusted accordingly. Proof of functionality was demonstrated by a dye study that showed this microdisc could employ the two-stage metering and laser-actuated valving strategy in an automated fashion without the need to dismount, flip, and remount the disc during assay optimization.

These three discs provide evidence of a customizable microfluidic platform capable of performing multiple reagent titrations in up to 100 different combinations, ultimately expediting assay time, minimizing manual intervention, and reducing reagent consumption.

### IV. Conclusions

The optimization of many traditional assays can be time-and labor-intensive, and when that optimization involves sample, two or more reagents, and multiple parallel experiments, this can result in the consumption of copious amounts of the reagents. It is for this reason that the NMD for automated, parallel titration of reagents using nano-volumes was developed and described here. Unlike similar existing devices,^{2,4,18} this rotationally-driven disc was fabricated from polymeric material using the PCL fabrication method²¹ that is ideal for rapid, iterative prototyping with cost-effective materials, costing <$1 USD and consuming less than 30 minutes to fabricate. The desire to have this be an autonomous system (once loaded) required a simple method for fluidic valving, and the laser-actuated valving approach exploiting black PeT functioned superbly in this role. However, what we describe here goes beyond simple opening of fluidic circuits. The laser valves have been used in a number of applications^{23,28-32} where the rectangular shape and size was purposeful for three reasons: 1) the 2D size (width, height) presented a large target for repeatable laser ablation of an 80 μm opening, 2) the rectangular shape (width>height) compensated for the slightly poorer accuracy in finding the exact angular coordinate (defined by the motor), and 3) after opening, the 1.5 mm×2.5 mm×0.1 mm valve typically retained less than 1 μL, a negligible volume of fluid relative to what was ported through the valve. However, it became clear that treating the valve less as transitory architecture and more like a chamber offered the potential for a new functionality—metering.

Ignoring its transitory function and focusing on metering, the dimensions and shape of the valve become important, and initial proof-of-principle experiments demonstrated two-stage metering with a starting volume of ˜700 nL. With this method, three variables contributed to the volume of fluid dispensed into detection chambers: (1) the valve shape, (2) the radial and angular positioning of the laser ablated opening in the valve, and (3) the architecture feeding fluid into the valve. We methodically evaluated how these three variables affected the volume of fluid metered in the second stage, showing that circular and triangular valves lacked reproducibility in terms of opening the valve, while the rectangular valves were effective for controlled metering of fluid defined by a 100% success rate for valve opening at a specific position over hundreds of runs. Using the same radial and angular coordinates for hitting each of the top, middle, and bottom positions of the rectangular valves, shows excellent accuracy and precision, and this translates directly to the second metering stage where <200 nL volumes could be reproducibly metered.

We demonstrated proof of feasibility with the design of a microfluidic disc for assay optimization of a colorimetric reaction using a 16-chamber disc designed for presumptive testing of cocaine. Not only was the automation successful, but the advantage offered by reduced reagent volumes was obvious, along with a substantial reduction in sample consumption. In theory, this disc design could be expanded to empirically define the analytical range of a colorimetric indicator by increasing the number of metering and detection chambers and using nano-volumes of reagents that cannot be pipette by hand. Alternatively, detection chambers could be pre-loaded with a variety of colorimetric indicators for suspected CDS (e.g., Marquis Reagent, Mandelin Reagent, etc.) to test for mixtures of illicit drugs or permit one disc to test for a variety of them.

To demonstrate the effectiveness of this approach for bioassays, a 9-layer disc was fabricated containing 15 detection chambers in each of the two domains, with a ‘flip’ being required to access the reagents metered on the lower half of the disc. This NMD was employed for the automated titration of primers in a PCR for detection of SARS-COV-2 which, if carried out by pipetting, would require 6 full-volume reactions to be plated in triplicate. Results from the NMD method produced results with the same trend as the in-tube assay: C_{T} values decreased with increasing primer concentration. Additionally, the difference in the absolute C_{T} values from the NMD and tube differed by <1 C_{T}, and this slight decrease in PCR efficiency could be due to microdisc metering volumes for half-reactions (10 μL). From a DNA amplification perspective, the loss of <1 C_{T} is almost negligible when compared to the decrease in reagent consumption (by 50%), which significantly reduces the cost of assay optimization.

We queried to what extent the NMD could be ‘multiplexed’ for metering and quantitative detection which, ultimately, would be limited by the PCL fabrication method. Based on our experience, the distinct limitations would be: 1) laser cutter limitations on the width of the feed channel, 2) the minimal valve dimensions that can be ablated accurately with acceptable precision at the desired location of choice, and 3) the density of features (primarily chambers) that was possible without expanding the diameter of the disc. Maintaining a disc diameter of 120 mm, we showed the potential for customizing a multistage metering NMD in two ways. First, two discs where fabricated, one with a ‘6 reagent-metering’ capability and 52 detection chambers to enable the optimization of more assay components, and the other with ‘4-reagent metering’ but 100 detection chambers. The 4-reagent/100 chamber disc is interesting because it could accommodate the necessary combinations and permutations of assays performed in a traditional 96-well plate. Finally, to circumvent the inconvenience of the ‘flip’ protocol illustrated with the PCR primer titration, we demonstrated that a highly multiplexed single-sided disc could be designed, but required that valves in the lower ('flip') side of the disc be accessed through a cutout in the top side of the disc. While these three discs were not explored beyond a preliminary dye study, they exemplify how the NMD is customizable, and can facilitate assay optimization equivalent of a 96-well plate with minimal manual intervention and reduced reagent consumption.

Overall, this inexpensive microfluidic disc enables nanoliter volume of fluid to be metered and manipulated with minimal manual intervention. This platform can conduct multiple reactions in parallel in an automated, cost-effective manner that removes the human variability and error associated with standard pipettes, and it does so using a fraction of the volume of reagents needed for in-tube (or in-well) assay optimization. The NMD can be modified to fit a variety of applications that require assay optimization of multivariate parameters, saving scientists copious amounts of time, effort, and resources.

### V. References for Example 1

1. A. Manz, N. Graber and H. M. Widmer, Sensors and Actuators B: Chemical, 1990, 1, 244-248.

2. P. Andersson, G. Jesson, G. Kylberg, G. Ekstrand and G. Thorsen, Anal Chem, 2007, 79,4022-4030.

3. X. Xu, L. Lin, J. Yang, W. Qian, R. Su, X. Guo, L. Cai, Z. Zhao, J. Song and C. Yang, Nano Today, 2022, 46, 101596.

4. K. Morikawa, S. Murata, Y. Kazoe, K. Mawatari and T. Kitamori, J Micromech Microeng, 2022, 32.

5. T. D. Anyaduba, J. A. Otoo and T. S. Schlappi, Micromachines, 2022, 13, 1946.

6. K. Serita and M. Tonouchi, 2022.

7. J. Zhang, Y. Liu, S. Ronneberger, N. V. Tarakina, N. Merbouh and F. F. Loeffler, Advanced Materials, 2022, 34, 2108493.

8. S. R. Ahmed, R. Chand, S. Kumar, N. Mittal, S. Srinivasan and A. R. Rajabzadeh, TrAC Trends in Analytical Chemistry, 2020, 131, 116006.

9. E. M. Elnifro, A. M. Ashshi, R. J. Cooper and P. E. Klapper, Clin Microbiol Rev, 2000, 13, 559-570.

10. K. Shah and P. Maghsoudlou, Br J Hosp Med (Lond), 2016, 77, C98-101.

11. A. McPherson and B. Cudney, Acta Crystallogr F Struct Biol Commun, 2014, 70, 1445-1467.

12. C. L. Hansen, E. Skordalakes, J. M. Berger and S. R. Quake, Proceedings of the National Academy of Sciences, 2002, 99, 16531-16536.

13. S. Haeberle and R. Zengerle, Lab Chip, 2007, 7, 1094-1110.

14. N. T. Hartner, K. Wink, C.-R. Raddatz, C. Thoben, M. Schirmer, S. Zimmermann and D. Belder, Anal Chem, 2021, 93, 13615-13623.

15. J. Probst, C. N. Borca, M. A. Newton, J. van Bokhoven, T. Huthwelker, S. Stavrakis and A. deMello, ACS Measurement Science Au, 2021, 1, 27-34.

16. D. Mark, S. Haeberle, G. Roth, F. von Stetten and R. Zengerle, Chem Soc Rev, 2010, 39, 1153-1182.

17. L. Clime, J. Daoud, D. Brassard, L. Malic, M. Geissler and T. Veres, Microfluid Nanofluid, 2019, 23, 29.

18. D. Mark, P. Weber, S. Lutz, M. Focke, R. Zengerle and F. von Stetten, Microfluid Nanofluid, 2011, 10, 1279-1288.

19. O. Strohmeier, M. Keller, F. Schwemmer, S. Zehnle, D. Mark, F. von Stetten, R. Zengerle and N. Paust, Chem Soc Rev, 2015, 44, 6187-6229.

20. A.-G. Niculescu, C. Chircov, A. C. Bîrcă and A. M. Grumezescu, International Journal of Molecular Sciences, 2021, 22, 2011.

21. B. L. Thompson, Y. Ouyang, G. R. M. Duarte, E. Carrilho, S. T. Krauss and J. P. Landers, Nature Protocols, 2015, 10, 875-886.

22. J. L. Garcia-Cordero, D. Kurzbuch, F. Benito-Lopez, D. Diamond, L. P. Lee and A. J. Ricco, Lab Chip, 2010, 10, 2680-2687.

23. M. S. Woolf, L. M. Dignan, H. M. Lewis, C. J. Tomley, A. Q. Nauman and J. P. Landers, Lab Chip, 2020, 20, 1426-1440.

24. M. S. Woolf, L. M. Dignan, A. T. Scott and J. P. Landers, Nat Protoc, 2021, 16, 218-238.

25. S. T. Krauss, M. S. Woolf, K. C. Hadley, N. M. Collins, A. Q. Nauman and J. P. Landers, Sensor Actuat B-Chem, 2019, 284, 704-710.

26. K. C. O'Connell, M. B. Almeida, R. L. Nouwairi, E. T. Costen, N. K. Lawless, M. E. Charette, B. M. Stewart, S. L. Nixdorf and J. P. Landers, In Prep, 2023.

27. Clinical Laboratory Reference, 2023, 55.

28. L. M. Dignan, S. M. Karas, I. K. Mighell, W. R. Treene, J. P. Landers and M. S. Woolf, Analytica Chimica Acta, 2022, 1221, 340063.

29. L. M. Dignan, M. S. Woolf, C. J. Tomley, A. Q. Nauman and J. P. Landers, Anal Chem, 2021, 93, 7300-7309.

30. T. R. Layne, R. L. Nouwairi, R. Fleming, H. Blair and J. P. Landers, Micromachines, 2022, 13, 1657.

31. R. Turiello, L. M. Dignan, B. Thompson, M. Poulter, J. Hickey, J. Chapman and J. P. Landers, Anal Chem, 2022, 94, 3287-3295.

32. M. S. Woolf, L. L. Cunha, K. C. Hadley, R. P. Moffett and J. P. Landers, Analytica Chimica Acta, 2023, 1249, 340826.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A centrifugal microfluidic device, comprising:
a sample preparation domain, comprising:
a first reagent chamber;
a first distribution channel in fluidic communication with the first reagent chamber;
a first network of metering channels furcating from the first distribution channel;
a first plurality of valves, with individual valves in fluidic communication with individual metering channels; and
a plurality of detection chambers with individual detection chambers connected to individual valves.

2. The centrifugal microfluidic device of claim 1, wherein individual sample preparation domains further comprise:
a waste chamber in fluidic communication with the distribution channel for reagent overflow; and
a plurality of vents with individual vents attached to individual valves.

3. The centrifugal microfluidic device of claim 1, wherein the first plurality of valves are positioned at a same radial distance from a center of the body.

4. The centrifugal microfluidic device of claim 1, wherein a connection between individual valves and individual detection chambers are closed until an opening is formed in the individual valves via laser-ablation.

5. The centrifugal microfluidic device of claim 1, wherein individual metering channels are tapered to increase fluidic resistance.

6. The centrifugal microfluidic device of claim 1, wherein a shape of the first plurality of valves is one of at least: a polygonal prism, a square prism, a rectangular prism; a triangular prism, a cylinder, or a hexagonal prism.

7. The centrifugal microfluidic device of claim 1, wherein the first reagent chamber has an inlet channel for loading a fluid into the individual sample preparation domains.

8. The centrifugal microfluidic device of claim 1, wherein the individual sample preparation domains further comprise:
a second reagent chamber;
a second distribution channel in fluidic communication with the second reagent chamber;
a second network of metering channels furcating from the second distribution channel; and
a second plurality of valves, wherein individual valves from the first plurality of valves and individual valves from the second plurality of valves both connect to the individual detection chambers.

9. The centrifugal microfluidic device of claim 8, wherein the individual sample preparation domains further comprise:
a third reagent chamber;
a third distribution channel in fluidic communication with the third reagent chamber;
a third network of metering channels furcating from the third distribution channel; and
a third plurality of valves, wherein individual valves from the first plurality of valves, individual valves from the second plurality of valves, and individual valves from the third plurality of valves all connect to the individual detection chambers.

10. The centrifugal microfluidic device of claim 1, wherein individual metering channels and the corresponding individual valve are configured to hold about 100 to 400 nL of a fluid.

11. A method for metering a fluid, comprising:
rotating the centrifugal microfluidic device, rotationally driving the fluid through a network of metering channels and into a plurality of valves, wherein individual valves have a top region adjacent the individual metering channel and a bottom region on the side opposite the individual metering channel;
forming a first opening at a first location in individual valves, wherein the first location is in the top region of the individual valve; and
rotating the centrifugal microfluidic device, rotationally driving a first specified amount of the fluid from the plurality of valves to a plurality of detection chambers, wherein the first specified amount of the fluid is based at least in part on a radial distance of the first opening of the individual valves and the first location of the first opening.

12. The method of claim 11, further comprising loading the fluid into a plurality of reagent chambers of a centrifugal microfluidic device.

13. The method of claim 12, further comprising:
forming a second opening at a second location in the individual valves via laser ablation, wherein the second location is below the first location and between the top region and the bottom region; and
rotating the centrifugal microfluidic device, rotationally driving a second specified amount of fluid from the plurality of valves to the plurality of detection chambers.

14. The method of claim 13, further comprising:
forming a third opening at a third location in the individual valves via laser ablation, wherein the third location is in the bottom region and is below the second location, wherein the second location is in a region between the first location and the third location; and
rotating the centrifugal microfluidic device, rotationally driving a third specified amount of fluid from the plurality of valves to the plurality of detection chambers.

15. The method of claim 11, wherein the specified amount of the fluid is approximately 100 nL to 1 μL of fluid.

16. The method of claim 11, wherein individual metering channels and the corresponding individual valve are configured to hold about 100 to 400 nL of a fluid.

17. A system, comprising
a laser; and
a centrifugal microfluidic device with a plurality of layers forming a body, wherein the body comprises a plurality of sample preparation domains, individual sample preparation domains comprising:
one or more reagent chambers;
one or more networks of metering channels furcating from the one or more reagent chambers;
one or more sets of a plurality of valves distributed among the one or more networks of metering channels such that individual metering channels fill individual valves;
one or more waste chambers connected to the one or more networks of metering channels for reagent overflow;
a plurality of detection chambers with individual detection chambers connected to one or more individual valves; and
a plurality of vents with individual vents attached to individual valves.

18. The system of claim 17, wherein the laser is configured to ablate the one or more sets of the plurality of valves creating an opening in individual valves.

19. The system of claim 17, wherein the plurality of layers forming the body comprises:
two or more clear polyethylene terephthalate (PeT) layers;
two or more heat sensitive adhesive flanked PeT layers; and
one or more optically dense black PeT layer.

20. The system of claim 17, wherein respective sets of the plurality of valves are positioned at a same radial distance from a center of the body; wherein the one or more networks of metering channels are tapered to increase fluidic resistance; and wherein a shape of the one or more sets of the plurality of valves is one of at least: a polygonal prism, a square prism, a rectangular prism, a triangular prism, a cylinder, or a hexagonal prism.
